(19) United States
(12) Patent Application Publication
(10) Pub. No.: US 2016/0064930 A1
(43) Pub. Date: Mar. 3, 2016

(54) AGGREGATED MICRO-GENERATOR ENERGY SOURCES FOR DELIVERING ENERGY TO A POWER GRID

(71) Applicant: VERSIFY SOLUTIONS, INC., Glen Mills, PA (US)

(72) Inventors: David IPPOLITO, Glen Mills, PA (US); Peter Cona, Chadds Ford, PA (US)

(73) Assignee: VERSIFY SOLUTIONS, INC., Glen Mills, PA (US)

(21) Appl. No.: 14/935,106

(22) Filed: Nov. 6, 2015

Related U.S. Application Data
(63) Continuation of application No. 12/437,388, filed on May 7, 2009.
(60) Provisional application No. 61/051,313, filed on May 7, 2008.

(51) Int. Cl. H02J 3/00; G05B 17/02

(52) U.S. Cl. CPC H02J 3/008; G05B 17/02

(57) ABSTRACT

An energy distribution system includes monitoring circuitry configured to monitor and communicate use of the distributed micro-generator energy sources, wherein the distributed micro-generator energy sources are configured to delivery energy to the power grid; a manager configured to develop a model describing an aggregation of the micro-generator energy sources based on an operating status and operating characteristics of the micro-generator energy sources; and an aggregator configured to aggregate the distributed micro-generator energy sources into an energy unit based on the model developed by the manager, the energy unit representing a chunk of energy to be provided to the power grid.

This application is a continuation of U.S. patent application Ser. No. 12/437,388, which was filed on May 7, 2009, and claims the benefit of U.S. provisional patent application No. 61/051,313, which was filed on May 7, 2008, both of which are incorporated herein by reference in their entirety.

### I. FIELD OF THE INVENTION

The present invention relates to a system facilitating the utilization of distributed micro-generators, and more particularly to a distributed micro-generator energy source aggregator, monitor, and manager. The present invention also relates to a performance monitor and reporter for distributed micro-generators, and more particularly to a performance monitor and reporter for distributed micro-generators that is adaptable to handle data from any data source.

### II. BACKGROUND OF THE INVENTION

Today, small generators (“micro-generators” with, typically, under 20 MW in capacity) represent a significant opportunity to the power industry in meeting the growing demands for energy. As commercial reliance on cheap consistent power becomes increasingly necessary, micro-generators are being deployed at industrial and commercial sites on a mass scale. Originally installed as a backup source of energy, in case power to a plant or facility is disrupted, these assets are currently underutilized and, in the aggregate, represent a significant power generation source across the grid. Furthermore, because these assets are located throughout the grid (and, are generally closer to where power is actually consumed, as opposed to traditional, larger power generators), this presents the added benefit of providing localized generator sources that are more distributed than the traditional sources; thus, this type of power generation can be described as distributed generation.

Distributed generators are not widely utilized to provide power to the grid for a number of reasons. First, companies that deploy this type of generation do so primarily for the purpose of having a backup power source and, further, these same entities generally do not understand the complexities of wholesale power markets because it is usually not within their set of core competencies, nor are there opportunities within. Also, traditional utilities and wholesale power producers have not had too much interest in these generators because of the relatively small power capabilities of these smaller generation technologies. Grid reliability and interconnection standards, developed for large scale power generators, also pose challenges to micro-generator asset owners, and have contributed to keeping many of their generation assets off of the grid. Furthermore, today's typical infrastructure and systems were not developed to scale to the order of magnitude required to support thousands (and potentially more) of micro-generators. As a result, today, much of this generation capacity sits largely idle.

Within the past few years, utilities have implemented what are called “demand response” (DR) programs, where customers agree to lower their power demand in exchange for either a fee, or a reduced power rate. Some of the customers participating in DR programs switch to their backup energy (e.g., micro-generators) in order to offset the power demand that they would have normally required from the local utility (or load serving entity). Although this model is effective in reducing the load/demand placed on a wholesale power producer, it still does not utilize the generation capacity of the backup energy resources during most other times, that is, during hours of non-peak demand.

Furthermore, in recent times, the power industry has been rapidly changing with the advent of deregulation as well as other socio-economic factors. As a result, increases in efficiency and control of power generation costs are becoming of more importance. To meet the industry needs, a large number of siloed information technology (IT) applications have been introduced. However, these applications are typically not built with integration in mind with each application being too proprietary in nature and specifically tailored for a particular power generation operation. Accordingly, collection and integration of data from these applications and systems are extremely difficult outside of the intended operation. Many utilities have sought to create a large scale data warehouse to solve this integration problem.

Another difficulty with prior art systems is the disparate number of locations even within the organization that need access to the data. For example, within a power company, traders on a central trade floor, plant personnel at each power plant, engineers stationed regionally, management dispersed throughout the organization, and third parties all need access to the data in some form. The traditional siloed applications are typically client-server based applications and it is difficult to provide access to everyone in need of the data.

In addition, due to the generally isolated nature of the prior art systems as described above, combining qualitative event type data (e.g., real-time or recorded plant operations data) and quantitative data (e.g., Supervisory Control and Data Acquisition (SCADA) and market data) becomes difficult and cumbersome, if not impossible, due to the size and disparity of the data. On the other hand, such information is important in determining proper operation of power generation as back office settlement activities determine penalties associated with under or over production of power, for example. Typically, back office personnel manually extract data from a number of different IT systems in the organization to determine the activities that occurred in prior reporting periods. Many times, logs maintained in word processing or hand written documents must be searched manually.

Moreover, when a type of report is required, IT developers have to develop some level of custom code to extract data from the data and format the data properly onto a report. This task becomes even more complicated when disparate data sources with varying data formats are used.

### III. SUMMARY OF THE INVENTION

Accordingly, the invention encompasses a system and method for aggregating, managing, and monitoring distributed micro-generator energy resources that substantially obviates one or more problems due to limitations and disadvantages of the related art.

Wholesale power producers and utilities that have the capability to aggregate, manage, and monitor small, distributed micro-generators are presented with the opportunity to leverage unused power sources, and profit from what are now nothing short of untapped, underutilized energy resources. The present invention presents several solutions and processes to help wholesale power producers aggregate, manage, and monitor distributed micro-generation facilities. The invention comprises a software system that allows a wholesale power producer or utility to aggregate, manage, and monitor micro-generator assets as larger, more manageable assets within the power markets on at least a daily basis; moreover, the invention also provides features for communication between the wholesale utility and the micro-generator owner, manager, or administrator. As wholesale power companies and utilities contract with micro-generator owners for the rights to the power output from their micro-generators, the present invention manages and tracks the key information about the generation capacity, availability, and power generator unit characteristics. This information is then coupled with market forecast information, and historical asset performance details, to produce at least daily models describing how the individual, distributed, micro-generator assets will be aggregated in order to maximize overall system performance; all of this information is then made available in at least a summary, report-type format, for use by portfolio managers accessing the present invention via an instance customized for the wholesale power company. According to this model, the distributed, micro-generator units are aggregated into larger blocks of energy products that a wholesale power company may choose to utilize, trade, and leverage in the market. The micro-generators that make up these energy products (or, blocks) could change on a day-to-day, hour-by-hour basis, according to at least: (a) the type of energy product being developed, (b) the micro-generator(s') operating characteristics, and (c) market forecasts, such that an entire set of small micro-turbines can be properly optimized.

Once the model is established, micro-generator asset owners would then be notified of the plans of a portfolio manager of a wholesale power company via the system of the present invention. Asset owners would then use the system for monitoring their own micro-generators' performance in the market, as well as a communications tool for transmitting and receiving messages to and from the wholesale power company's portfolio managers. The system also provides the capability to communicate with the utility's energy management systems (EMS) to automate and rapidly transmit information, about what assets have been identified as part of each energy block, to real time SCADA systems that are responsible for controlling generator operations.

This type of system is innovative and unique in that it will provide features to wholesale power producers that would allow them to leverage the use of micro-generator assets, which they currently do not use during peak hours. By leveraging these types of power sources through contractual arrangements, wholesale power producers will be able to recognize new revenue streams by participating in an energy market that they otherwise could not leverage due to a lack of specialized expertise and an economy of scale.

Furthermore, from three different perspectives, the invention addresses a set of problems currently faced. The invention addresses problems faced by ISO's (e.g., PJM, NEISO, NYISO, MISO), wholesale power producers, and micro-generator owners. With respect to the ISO's, having additional generation sites offers additional capacity to off-load peak electricity demand requirements. In addition, having additional generation sites can assist with grid reliability.

With respect to the wholesale power producers/utilities (discussed above), the invention addresses problems related to scalability, automation, communication, and cost. As for scalability, software solutions implemented for traditional power plants were only required to support up to 200 power plant sites; this is mainly because each power company owned a very finite number of assets that grew by approximately 1 to 2 percent (%) each year. In the case of distributed generation, however, this same software would now be required to support a much larger number of disparately located micro-generators (possibly in excess of 10,000 or more). Today's in-house and commercially available software in the market was not built with this level of scalability in mind. As a result, companies entering the distributed generation market now require a new kind of software that is designed to support much larger numbers of generation facilities and much larger volumes of power generation data.

As for automation, power companies will not be required to manage the dispatch and operation of a large number of distributed micro-generators. Typical dispatch operations today rely on manual processes such as phone calls to and from generation facilities. Given the volume of the distributed micro-generation resources that must be managed simultaneously, traditional dispatch and management processes are not feasible. By automating processes and communications between portfolio managers, energy management systems, and asset owners, the present invention provides key tools to address the steep increase in business processes and transactions that will be executed and managed.

As for communication, traditionally, most of a power company's assets were interconnected via the company's own private network. In the case of certain contractual agreements with others, dedicated lines might have been allocated to connect assets outside of the network. As a result, IT departments were able to deploy software solutions across their network to make functionality available at disparate locations. However, in a distributed generation environment with independent micro-generator owners, the power company's internal network cannot serve as the means to distribute software and automate key processes. Because the present invention presents a web-enabled solution (unlike most other commercially available software), it is accessible over a secure internet connection via a browser and solves the problem of having to network a large number of users at independently owned companies. Real-time communication among all participants in the distributed micro-generation value chain will significantly improve the automation of key processes, while enabling the management of a far greater volume of generation resources.

As for cost, without advancements in software scalability and in automating generation management processes, costs to implement distributed generation in a reliable seamless manner will be prohibitive to successful adoption in the industry. The present invention's unique technology provides the underlying scalable architecture to efficiently address the demanding needs of the emerging and increasingly distributed nature of the electricity power grid.

Finally, with respect to the micro-generator owners, who have installed backup power facilities at their locations, there is a cost associated with power disruptions that far exceeds the cost of backup generation. These owners/companies, however, are not familiar with the wholesale power industry, and do not wish to make substantial investments to participate in markets outside of their core business competencies. The present invention offers them tools and solutions to allow their participation in power energy markets through agreements with a wholesale power company or utility that offers such programs. To participate in these markets, micro-generator owners would have to communicate power availability to the wholesale power company, be notified when their assets are scheduled to run by the wholesale power company, and report on their assets' performance for maintenance, settlement and profit and loss (i.e., P&L) purposes. The present invention provides tools and solutions to address all of these issues and, thus, provides micro-generator owners with the ability to generate revenue from a typically under-utilized backup generator.

The present invention is also directed to a system and method for monitoring distributed micro-generation operations that substantially obviates one or more problems due to limitations and disadvantages of the related art.

Another object of the present invention is to provide a system and method for collecting distributed micro-generation operation data from disparate data sources and for generating a report of the performance of the operation.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one embodiment, the invention encompasses a system for managing distributed micro-generator energy sources, the system includes an aggregator of distributed micro-generator energy sources, a monitor of distributed micro-generator energy sources, where the monitor communicates micro-generator energy usage data with a wholesale power producer and a micro-generator asset owner, and a manager of distributed micro-generator energy sources, where the manager facilitates control of a micro-generator energy source by assigning a specific micro-generator energy source to a wholesale power producer, wherein the monitor tracks and reports micro-generator energy source use by a wholesale producer.

In one embodiment, the invention encompasses a method for managing distributed micro-generator energy sources, the method includes aggregating distributed micro-generator energy sources, monitoring the distributed micro-generator energy sources by communicating micro-generator energy usage data with a wholesale power producer and a micro-generator asset owner, and managing the distributed micro-generator energy sources by facilitating control of a micro-generator energy source by assigning a specific micro-generator energy source to a wholesale power producer, wherein the monitoring step further includes the step of tracking and reporting micro-generator energy source use by a wholesale producer.

In another embodiment, the invention encompasses a system that includes a communications network, a plurality of remotely located data sources to provide power data, the power data including quantitative and qualitative data of one or more distributed micro-generator units, and a performance monitor in communication with the plurality of remotely located data sources through the communications network, the performance monitor including a communications unit to extract the power data from the plurality of remotely located data sources, a data conversion unit to transform the power data into a common data format, a data store to store the transformed power data, and a user interface unit to display the transformed power data on one or more client devices through the communications network.

In yet another embodiment, the invention encompasses a method that includes communicating with a plurality of remotely located data sources from a performance monitor via a communications network, the plurality of remotely located data sources providing power data including quantitative and qualitative data of one or more distributed micro-generator units, extracting the power data from the plurality of remotely located data sources, transforming the extracted power data into a common data format, storing the transformed power data in a data store, and displaying the transformed power data on one or more client devices through the communications network.

It is to be understood that both the foregoing general description and the following detailed description are exemplary and explanatory and are intended to provide further explanation of the invention as claimed.

### IV. BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a block diagram illustrating an overall system architecture of an exemplary embodiment of the present invention;

FIG. 2 shows a block diagram illustrating the overall high-level interactions among the various entities that interface with the present invention;

FIG. 3 shows a block diagram illustrating the asset profile database: customer signed decomposition flows;

FIG. 4 shows a block diagram illustrating a high-level summary of the portfolio management application flows;

FIG. 5 shows a block diagram illustrating the portfolio management: market participation flows;

FIG. 6 shows a block diagram illustrating the portfolio management: daily market operations flows;

FIG. 7 shows a block diagram illustrating the control/dispatch center application: program participation flows;

FIG. 8 shows a block diagram illustrating the control/dispatch center application: monitor real time operations flows;

FIG. 9 shows a block diagram illustrating the back office application: settlement flows;

FIG. 10 shows screen captures illustrating the user interfaces that the various entities use for portfolio management in accordance with the present invention;

FIG. 11 shows a block diagram illustrating an overall system architecture of an exemplary embodiment of a monitoring and reporting feature of the present invention;

FIG. 12 shows a block diagram illustrating an exemplary embodiment of a communication interface architecture of the present invention;

FIG. 13 is an example of a config file in accordance with the present invention;

FIG. 14 shows a block diagram illustrating an exemplary embodiment of generating a report interface in accordance with the present invention;

FIGS. 15A-15K show exemplary embodiments of a dashboard report interface in accordance with the present invention;

FIGS. 16A and 16B show exemplary embodiments of a daily report interface in accordance with the present invention;

FIGS. 17A and 17B show exemplary embodiments of a unit performance report interface in accordance with the present invention;

FIG. 18 illustrates an exemplary unit interface in accordance with the present invention;

FIG. 19 illustrates an exemplary unit attribute interface in accordance with the present invention;

FIG. 20 illustrates an exemplary event log interface in accordance with the present invention; and

FIGS. 21A and 21B illustrate an exemplary real time monitor in accordance with the present invention.

### V. DETAILED DESCRIPTION OF THE INVENTION

### General Description

The invention generally encompasses systems including:

an aggregator of distributed micro-generator energy sources;

a monitor of distributed micro-generator energy sources, the monitor communicates micro-generator energy usage data with a wholesale power producer and a micro-generator asset owner; and

a manager of distributed micro-generator energy sources, the manager facilitates control of a micro-generator energy source by assigning a specific micro-generator energy source to a wholesale power producer,

wherein the monitor tracks and reports micro-generator energy source use by a wholesale producer.

In certain illustrative embodiments, the manager optimizes micro-generator energy source usage.

In certain illustrative embodiments, the optimization is executed according to a market condition.

In certain illustrative embodiments, the optimization is executed according to a micro-generator energy source asset mix.

In certain illustrative embodiments, the manager suggests an allocation of micro-generator energy sources.

In certain illustrative embodiments, the manager develops a bid and an offer price for energy trading in an energy trading market.

In other embodiments the invention encompasses computer-implemented methods including:

aggregating distributed micro-generator energy sources;

monitoring the distributed micro-generator energy sources by communicating micro-generator energy usage data with a wholesale power producer and a micro-generator asset owner; and

managing the distributed micro-generator energy sources by facilitating control of a micro-generator energy source by assigning a specific micro-generator energy source to a wholesale power producer,

wherein the monitoring step further includes the step of tracking and reporting micro-generator energy source use by a wholesale producer.

In certain illustrative embodiments, the managing step further comprises optimizing micro-generator energy source usage.

In certain illustrative embodiments, the optimizing is executed according to a market condition.

In certain illustrative embodiments, the optimizing is executed according to a micro-generator energy source asset mix.

In certain illustrative embodiments, the managing step further comprises suggesting an allocation of micro-generator energy sources.

In certain illustrative embodiments, the managing step further comprises developing a bid and an offer price for energy trading in an energy trading market.

In another embodiment, the invention encompasses:

a communications network;

a plurality of remotely located data sources to provide power data, the power data including quantitative and qualitative data of one or more distributed micro-generator units; and

a performance monitor in communication with the plurality of remotely located data sources through the communications network, the performance monitor including:

a communications unit to extract the power data from the plurality of remotely located data sources,

a data conversion unit to transform the power data into a common data format,

a data store to store the transformed power data, and

a user interface unit to display the transformed power data on one or more client devices through the communications network.

In certain illustrative embodiments, the transformed power data is displayed on one or more client devices as a report.

In certain illustrative embodiments, the report is within a web browser.

In certain illustrative embodiments, the report is customized according to a variable.

In certain illustrative embodiments, the variable is chosen by a user of the one or more client devices.

In other embodiments the invention encompasses computer-implemented methods including:

communicating with a plurality of remotely located data sources from a performance monitor via a communications network, the plurality of remotely located data sources providing power data including quantitative and qualitative data of one or more distributed micro-generator units,

extracting the power data from the plurality of remotely located data sources,

transforming the extracted power data into a common data format,

storing the transformed power data in a data store, and

displaying the transformed power data on one or more client devices through the communications network.

In certain illustrative embodiments, the transformed power data is displayed on one or more client devices as a report.

In certain illustrative embodiments, the report is within a web browser.

In certain illustrative embodiments, the report is customized according to a variable.

In certain illustrative embodiments, the variable is chosen by a user of the one or more client devices.

Reference will now be made in detail to the embodiments of the present invention, examples of which are illustrated in the accompanying drawings.

The system of the present invention would be employed at a centralized location using one or more database and web application servers. Each wholesale power company (e.g., utility) would have a centrally managed system comprising web applications and databases. Employees at the wholesale power company could access the data of the present invention through a web-based user interface. As one or more deals/contracts are made between a wholesale power company and a micro-generator owner, to leverage the micro-generator's power assets, deal and generator detail is added to one or more of the system's databases. At the wholesale power company, portfolio managers (e.g., planners) would then use the system to plan the current day's and next day's (or, over more expansive time-intervals) energy usage. After aggregating the micro-generators available for the deal based on one or more criteria (e.g., usage, capacity, schedule, price, etc.), the system then determines (e.g., assigns) which micro-generators make up each block of power to be bought and sold into various power markets. As a micro-generator asset is identified for use, the generation owner is alerted through the system. Generation owners could then use the system to review past, current, and future plans for their micro-generation asset(s), alert the wholesale power company as to any issues or problems, and monitor usage. The system then makes performance reports available to the asset owner and the wholesale power company; the performance reports comprise detailed usage data, cost data, and revenue data. The system then transmits data to the wholesale power company's other internal operations, management, analysis, settlement, or other systems, if necessary. For example, planned/scheduled usage data is sent to energy management systems (EMS), risk analysis applications, and back office settlement systems.

The present invention's reporting and notification software (described below) is centered with respect to planning, operational, and settlement activities associated with operating distributed micro-generation assets. For example, as portfolio managers plan to use assets, they could access the reporting features that display key information, such as number of hours remaining under a given deal/contract, and the likelihood that an asset value will be greater in the future. Asset owners could use the reporting features (described below) to view and analyze reports displaying how a portfolio manager intends to use the asset, the market value, and other key planning information such as hours remaining under contract. Portfolio managers, in realtime, could review summary level reporting of all assets, as well as drill down to a particularly subset of generators. Micro-generator asset owners, in realtime, could access key operational data for their asset(s), as well as how that data relates to planned usage. Finally, settlement type reporting is available to portfolio managers to assist in ISO settlement processes, as well as the secondary settlement required with each micro-generator asset owner. Each micro-generator asset owner also has access to dashboards and reports (described below) tailored to their individual deal/contract requirements.

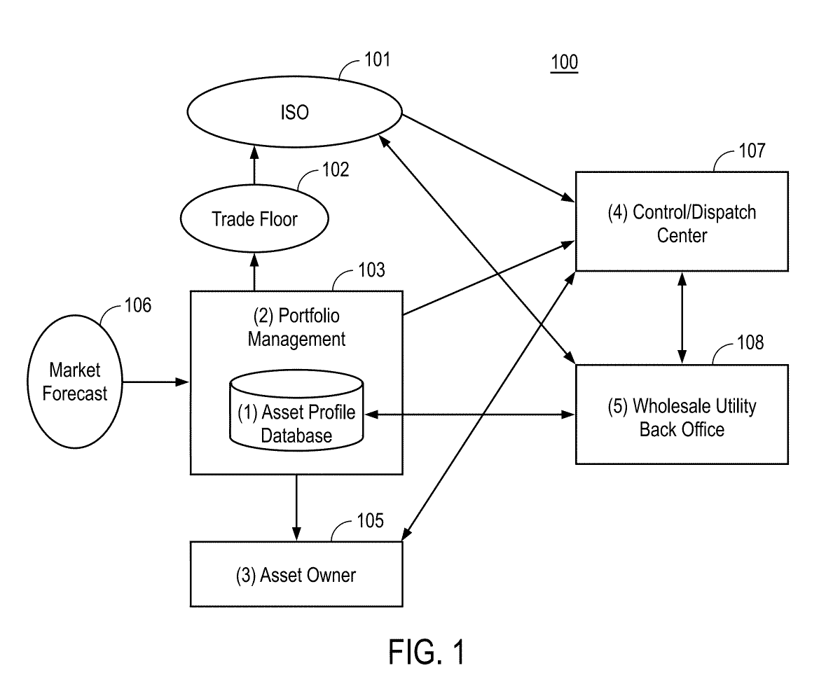

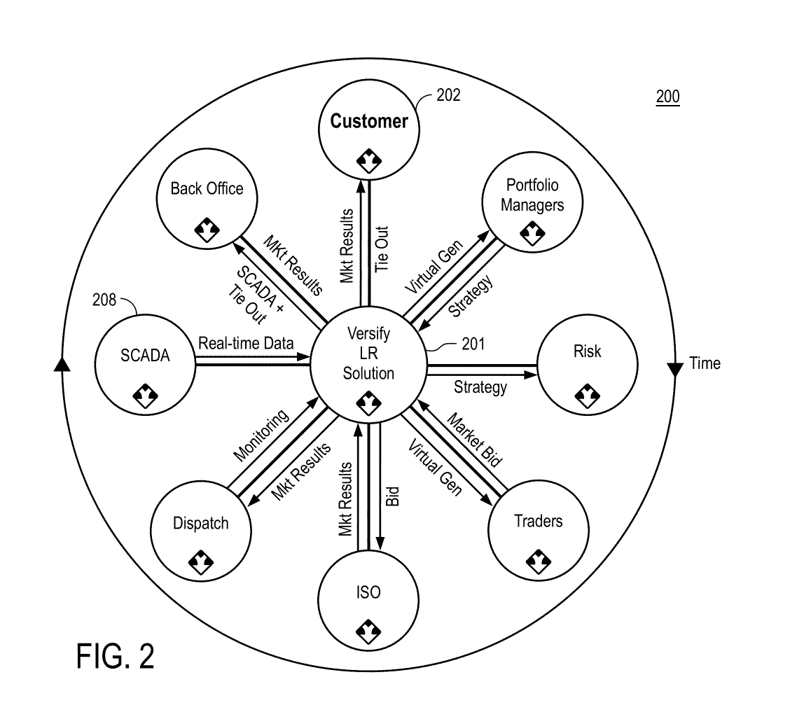

In one embodiment of the system 100, as shown in FIG. 1, the system 100 is comprised of: (a) an Asset Profile Database 104 (a database of the micro-generator capacity and availability characteristics, with GIS encoding); (b) a Portfolio Management Application 103 (incorporates market forecast data and historical data, and analyzes the market opportunity in conjunction with the Asset Profile Database 104 to determine market trading strategies); (c) an Asset Owner Application 105 (also referred to as a Small Generator Application) (to facilitate management, usage, and communications with micro-generator asset owners); (d) a Dispatch/Control Center Application 107 (for realtime monitoring of asset performance, automatic dispatch log, communication of trading activities, and asset availability); and (e) a Wholesale Utility Back Office Application 108 (records asset usage and tie and settlement data, and provides asset reporting via dashboard reports and drill down data systems, and includes P&L).

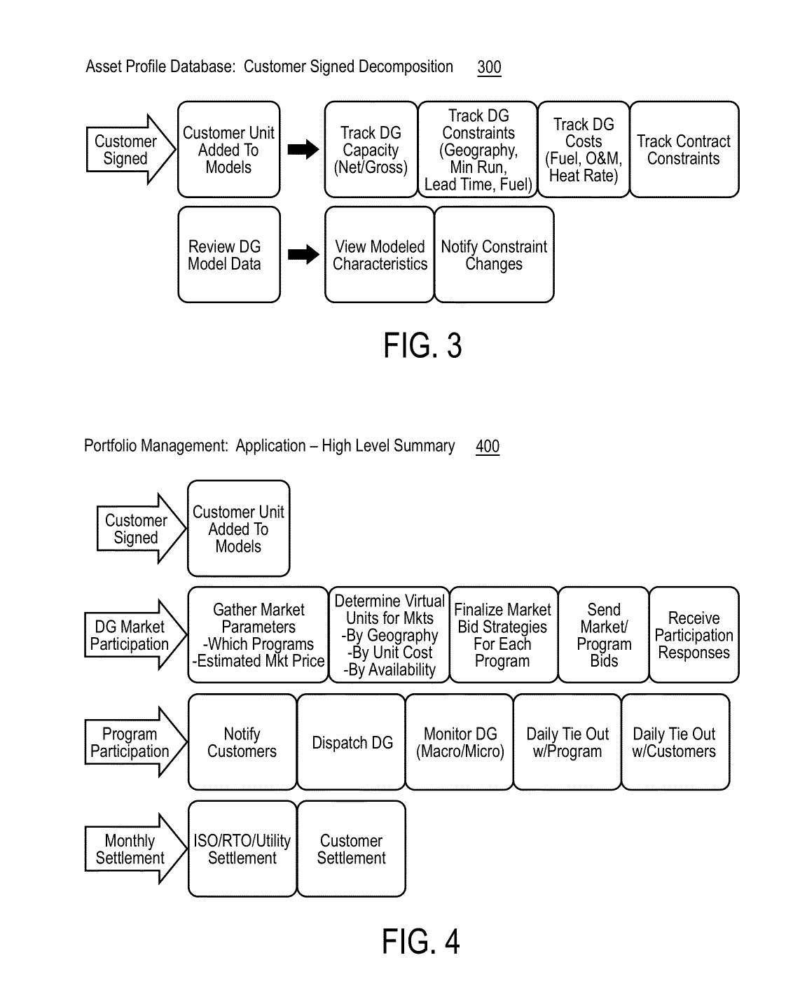

The Asset Profile Database 104, as shown in FIG. 1, is initialized for storing data once a customer (e.g., micro-generator owner) has signed a contract with a wholesale power producer. The terms of the contract (e.g., allowed usage, minimum run, lead time/scheduling, price, cost, capacity, etc.) as well as details regarding the customer's assets (e.g., physical characteristics of a micro-generator like fuel, O&M, heat rate, etc.) are added to the system and to the database. The customer then has access to their own data, and may verify and identify any discrepancies. FIG. 3 illustrates the operations of this process in the asset profile database: customer signed decomposition flow 300.

The Portfolio Management Application 103, as shown in FIG. 1, is a centralized application used by portfolio managers at a wholesale power company or utility to plan usage of and monitor a large number of distributed micro-generation assets in a number of power markets; it is also a customer-based reporting tool, directed towards asset owners, that continuously monitors micro-generators and sends notifications to asset owners regarding planned usage, as well as report on actual generation in realtime and after-the-fact. The Application 103 may report such information to a trade floor 102, which may then report the information to one or more ISO's 101. In addition, the Application 103 may receive market forecast data 106. In order to perform the monitoring function, the Application 103 connects to each micro-generator's network management system, or other accessible database, and retrieves the appropriate information regarding status, usage, load, capacity, or other characteristics. Once the data is retrieved, it is stored and analyze according to the various reporting capabilities available in the present invention (as described below). At such time, a wholesale power producer 108 and micro-generator asset owner may access the summary and reporting features to receive the respective monitoring data. The Portfolio Management Application 103 is used by wholesale power companies/utilities to track each micro-generator asset under management. It may also serve as a central warehouse for generator data, and as a planning engine that a portfolio manager could use on a daily basis to optimize asset usage based on the manager asset mix and current market conditions. FIG. 4 illustrates the high-level business processes 400 that are addressed by the Portfolio Management Application 103.

The system of the present invention includes key planning and modeling activities, which allow a portfolio manager to model, optimize, and plan usage for an entire portfolio of micro-generator assets, within market parameters. A portfolio manager may utilize an asset one way on a given day to produce a product highly valued by that day's market, and in an entirely different manner the next day, according to new market conditions. Furthermore, within these planning functions, the portfolio manager will also be able to add value to existing large scale power generators by offsetting inefficiencies to these generators with the smaller assets.

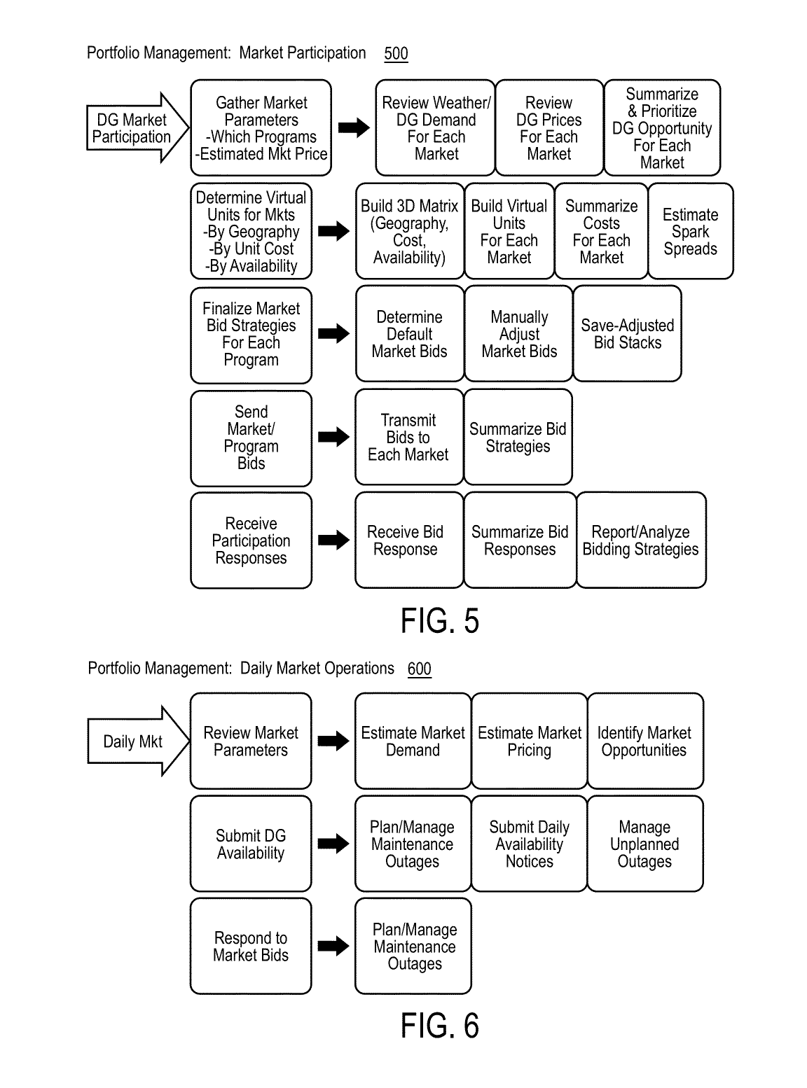

As briefly described above, a portfolio manager at the wholesale power company may utilize the system 100 of the present invention to plan market participation for the current and next day. The portfolio manager is considered an expert on power markets and has key insight into where market opportunities lie (i.e., both geographically and from a power product perspective), and understands the wholesale power company's current risk portfolio. The portfolio manager enters key market parameters that describe where market value may lie into the portfolio management application of the system. The system 100 then analyzes the entered market parameters, as well as each available micro-generation asset, to develop a model of how the available assets can be utilized to maximize profit; this model is then communicated to the portfolio manager, or other system user, via the user interface or reporting features of the present invention. The smaller distributed micro-generation assets are combined or “aggregated” by the system into larger, manageable “virtual” assets that the portfolio manager may then trade into each market. For example, the portfolio manager may see value in a capacity market in a particular geographic region. After analyzing all of the available micro-generator assets, the system 100 may suggest to the portfolio manager the allocation of, for example, 150 distributed micro-generation assets into a trade-able chunk of capacity. The portfolio manager may accept the suggestion, or alter it in some way (perhaps returning 20 of those assets back to the asset pool and only trading capacity from 130 assets). These plans are also communicated to each customer (e.g., micro-generator asset owner) who owns an asset that is included in the plan presented to the portfolio manger (typically, via the Customer Application 202, described below). Customers may have the ability to opt in our out of a particular plan. Once all of the plans are finalized (there are multiple power products, and multiple geographic regions that may be traded), the system develops bids and offers to be sent into each market, for buying and selling energy products as desired. The system will receive the market results as bids and offers are accepted. The Portfolio Management Application 103 allows the portfolio manager to manage market operations and portfolio decisions on daily basis. FIGS. 5 and 6 illustrate the operations of this portfolio management process in the decomposition flows 500, 600.

The Asset Owner Application 105, as shown in FIG. 1, is targeted towards each micro-generator asset owner who contracts with a central utility in order for the utility to leverage and manage use of the asset. The application is the key communications tool between the asset owner, the portfolio managers, and the dispatchers at the utility. The application 105 automates and optimizes communications between the asset owners and the wholesale power company, over the system. The application 105 allows asset owners to view conditions about the usage of their assets, and monitor dispatch activities in real time while allowing communications with the Control/Dispatch Center 107.

An asset owner communicates any availability information to the central database on a daily basis. Unless otherwise notified, the system 100 assumes the asset is available per usage according to the contract. If for some reason an asset is unavailable, the asset owner uses the system 100 and, particularly, the Asset Owner Application 105 to notify the utility. Also, when an asset owner's micro-generator is included in the same day's energy plans, the owner is notified via the customer application. Depending on the contract, the asset owner may opt in or out of that day's activities.

The Control/Dispatch Center Application 107, as shown in FIG. 1, provides real-time monitoring capability so that a control center can manage the generation asset in realtime. Dispatchers have access to real time and historical data about the generation unit. A dispatch login application also provides dispatchers an ability to log dispatch events for record keeping purposes.

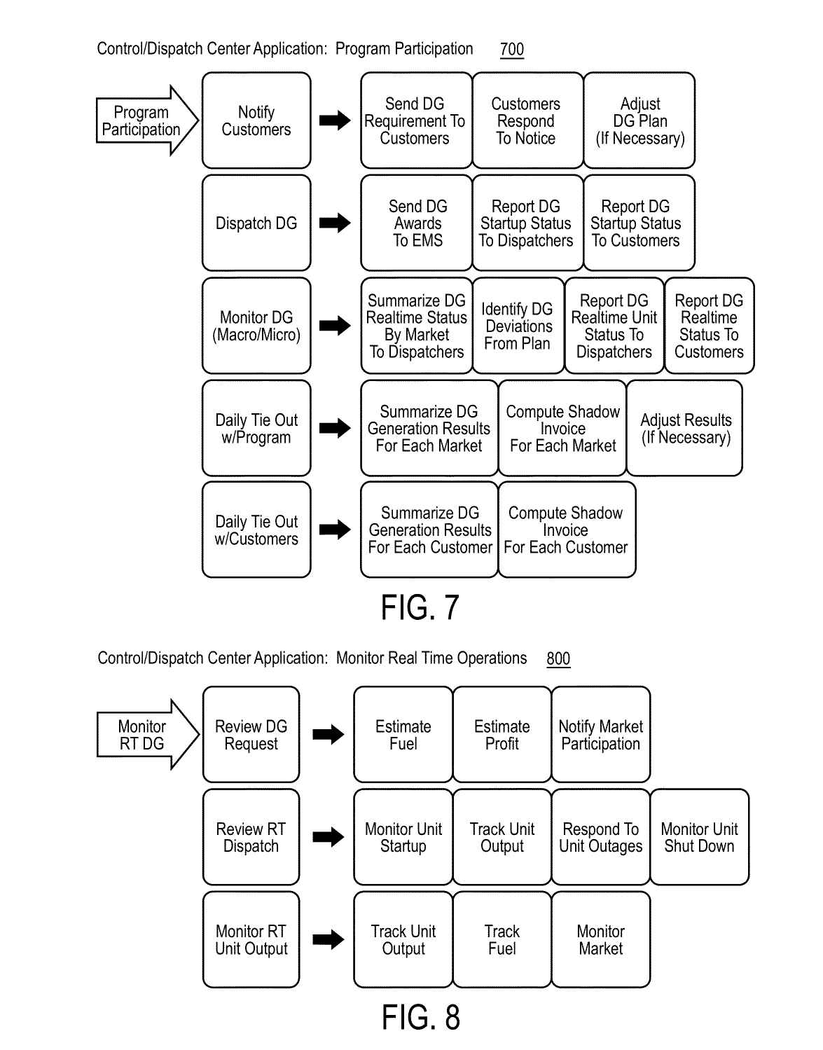

The Control/Dispatch Center Application 107 also includes a program participation capability. When bids and offers are accepted, the wholesale power company is committed to producing the power products that have been bought and sold. The system 100 of the present invention, specifically, the program participation capability, notifies asset owners of the assets to be utilized and the plan for their utilization. The system 100 also notifies the wholesale power company's Energy Management System (EMS) of each resource and its allocation plan; the EMS is responsible for the actual operation of the power generation units according to the plan. The system 100 will monitor Supervisory Control and Data Acquisition systems (SCADA) and provide reports that allow portfolio managers and dispatchers to monitor the operation of each block of energy (or other product). The dispatcher or portfolio manager may drill down in each report to the asset level in order to monitor activity in greater detail. Due to the disparate location of the distributed generation resources that comprise a product block, a GIS user interface may be utilized to present large amounts of data via a simple-to-use user interface. Once the plan has been executed, the data is archived for reporting purposes. The reporting feature of the present invention, as applied to this application, includes: (a) high-level reporting to settle with the markets in which the power was traded; and (2) reporting for each micro-generator asset owner that will need information to settle the contract with the utility. FIGS. 7 and 8 illustrate the operations of the control/dispatch center application process in the decomposition flows 700, 800.

Furthermore, a Monitor DT capability is also provided. Once an asset has been allocated for use, and its plan is communicated to the wholesale power company's EMS, the unit is initiated remotely by the EMS. The asset owner is then able to monitor unit output via the customer application 202. The application is linked to the central SCADA system 208 that monitors usage for all generators operated by the EMS. Reports are then generated from the stream of SCADA system 208 data and communicated to the asset owner in a near real-time basis. Some of the data presented in the reports includes: MW produced, fuel data, emissions, and other key operational data.

FIG. 1 also shows the Wholesale Utility Back Office Application 108. This Application 108 is a back office-type application that manages a database of asset transactions for record keeping and reporting purposes. The reports generated are available for access by wholesale power producers and micro-generator asset owners, in accordance with appropriate privileges.

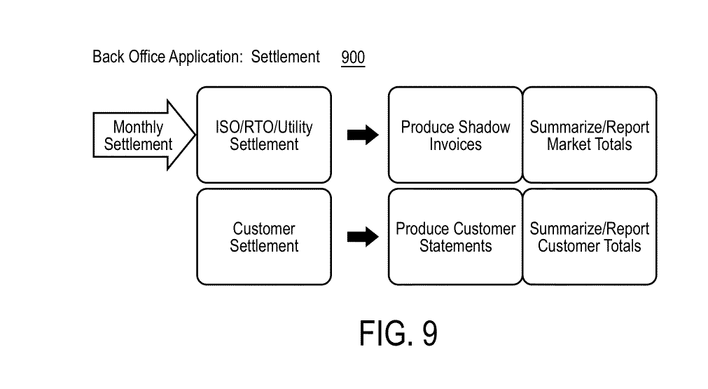

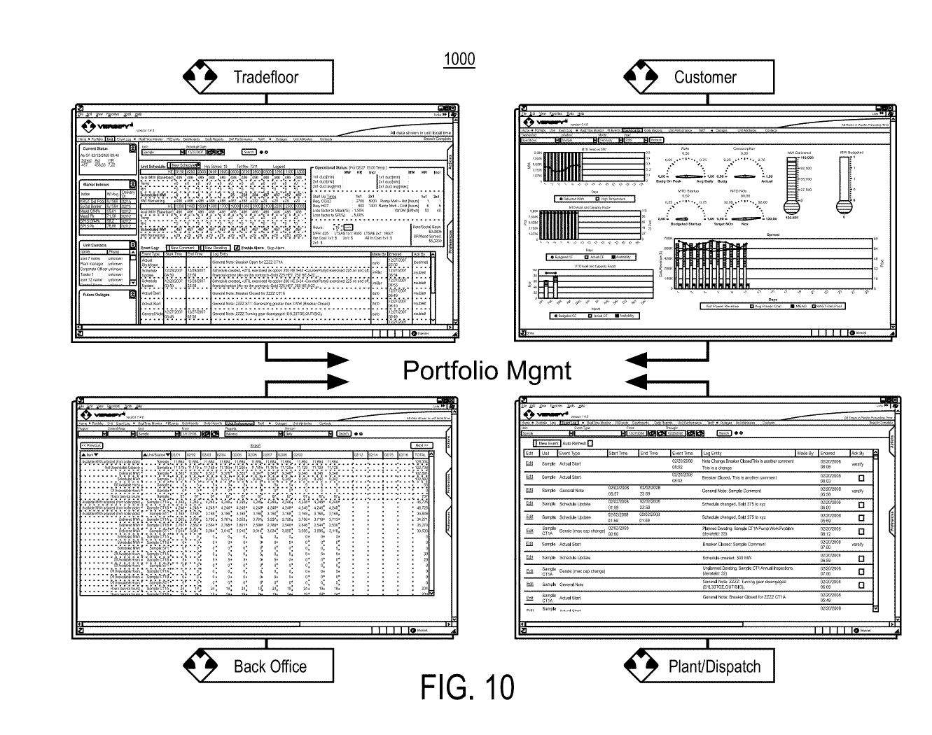

As stated above, there are two levels of settlement: ISO market settlement, and each customer's own contract with the utility. The system 100 of the present invention produces shadow settlement reports for use in back office invoice reconciliation. In addition, dashboard and other reports are also available via the customer application to help in contract settlement. FIG. 9 illustrates the back office application: settlement processes decomposition flow 900.

A system and method of a feature of the present invention is a flexible solution both in terms of the type and amount of data processed and in terms of monitoring and reporting to the above identified problems of the prior art. In general, a system and method of a feature of the present invention is a hosting asset performance monitoring and reporting tool used by owners/portfolio managers of power generators, such as independently owned utilities, municipalities, and cooperatives, as well as owners of distributed micro-generators, for example. It is to be understood that other users and benefits may be realized without departing from the scope of the invention.

Another feature of the present invention provides, for example, dashboard reporting (e.g., for management-level), summary/drill-down reporting (e.g., back office processing), daily operational reporting (e.g., operations), query interface for plant supervisory control and data acquisition (SCADA) information on ad-hoc basis, and near real-time status and logging capabilities. Accordingly, the system and method of the present invention provides, for example, logged information created by automated plant and micro-generator monitoring systems and/or plant personnel as events occur with relative SCADA and market information. The details of this system and method of the present invention is described below.

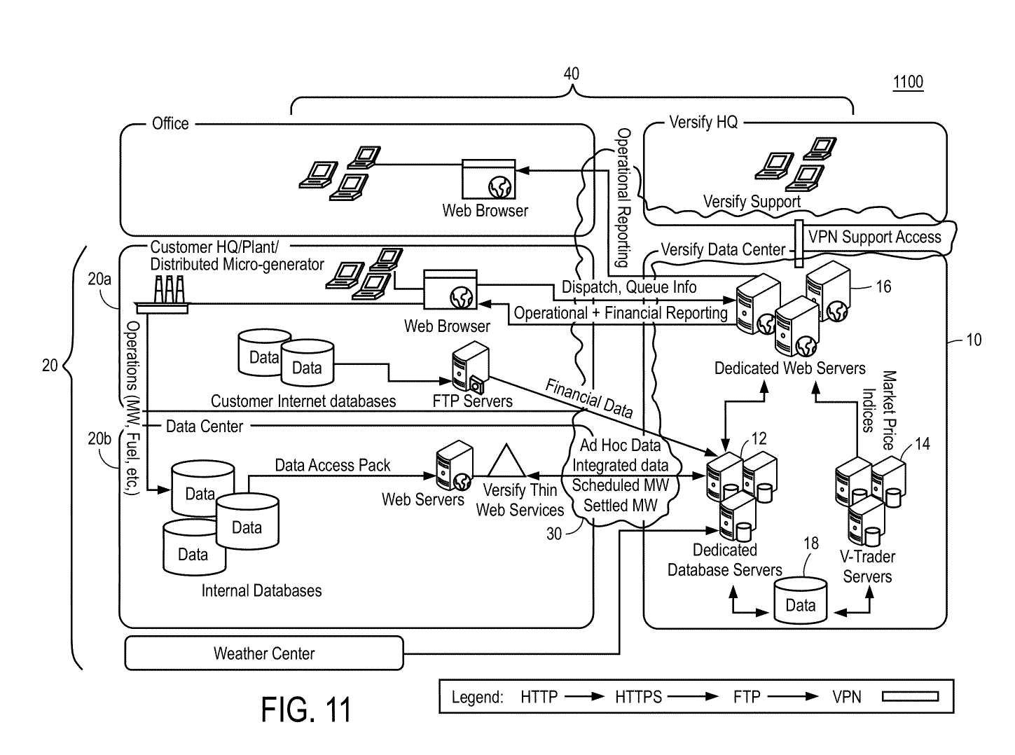

FIG. 11 shows a block diagram illustrating an overall system architecture 1100 of an exemplary embodiment of a monitoring and reporting feature of the present invention. As shown in FIG. 11, the system of this feature of the present invention includes a hosting monitoring center 10 in communication with a plurality of remotely located disparate data sources 20 over a communications network 30. The communications network 30 may be any data communications network, such as point-to-point connections, local area networks (LAN), wide area networks (WAN), Internet, etc. and may be over a wired or wireless communication medium. The remotely located disparate data sources 20 provide qualitative information (e.g., events type data) and quantitative information (e.g., market data) related to a hosted power generating unit, or distributed micro-generator. For example, as shown in FIG. 11, the hosting monitoring center 10 may be in communication with a hosted power plant/distributed micro-generator 20a and SCADA data center 20b. SCADA data center 20b may be any data source that archives time-series SCADA or telemetry data of a power generator or distributed micro-generator, may be sometimes referred to as SCADA historian, and tracks, for example, megawatts produced, fuel consumption, etc. Generally, SCADA data center 20b collects SCADA information from a plurality of power generators located within a defined region. However, any SCADA data source may be used without departing from the scope of the present invention. The hosted power plant/distributed micro-generator 20a provides internal operations data of the power plant/distributed micro-generator, such as operational event logs, the amount of power being generated, operational cost information (including unit design and budget data), etc. “Budget” data, as used herein, includes financial/cost expectations as well as operational expectations, such as expected hours of operation, expected number of starting the generators over a projected time frame, how much power is expected to be generated, etc. It is to be understood that the data provided by the hosted power plant/distributed micro-generator 20a may overlap with the information provide by the SCADA data center 20b and may be used independently of, or in conjunction with, each other. Other remote data sources may include market and financial information data services (not shown) that provide historic and real-time market information to the monitoring center 10.

The hosting monitoring center 10 includes power data server 12, market data server 14, and web server 16. It is to be understood that these servers may be implemented in a single machine or a plurality of machines without departing from the scope of the invention. The power data server 12 and market data server 14 are configured to obtain data from any number of the disparate data sources 20. The data sources 20 may be databases from hosted or unhosted systems, such as independent system operators (ISOs), regional system operators (RSOs), distributed micro-generators, and SCADA data centers, for example. The data may also be obtained from internal data sources of hosted and unhosted system, such as data from internal databases, spreadsheets, and other software packages. The power data server 12 and market data server 14 convert the collected data into a common format and store the transformed data in data store 18. The data store 18 may be a single or a plurality of data storage devices and may be implemented as a direct data repository or a relational database. Other data store configurations may be used without departing from the scope of the present invention. The web server 16 communicates with client devices 40 to provide monitoring functionality to the users. Client devices 40 may be workstations, notebooks, digital personal assistants, and other data-enabled devices. The web server 16 processes the requests from the client devices 40 and provides the requested information via reports and alarms to be described further below.

In an exemplary embodiment of the present invention, the web server 16 communicates with the client devices 40 via web-based applications. In the exemplary embodiment, the client devices 40 may only need a web browser and may not require any specialized applications. The web server 16 includes a proprietary XML:HTTP callback architecture to initiate requests from a browser from the client device 40, for example, back to the web server 16.

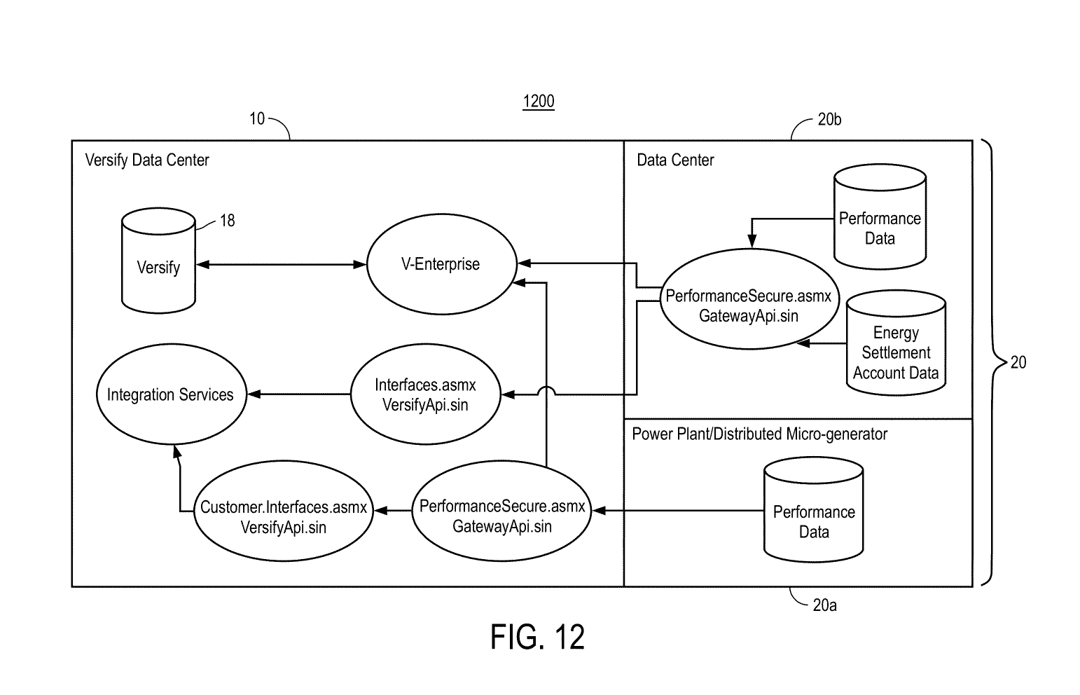

FIG. 12 shows a block diagram illustrating an exemplary embodiment of a communication interface architecture 1200 of the present invention. As shown in FIG. 12, the system and method of the present invention extracts data from any number of disparate data sources 20 using a combination of web services and integration services (e.g., SQL server). For example, the interface architecture 1200 in accordance with the exemplary embodiment of the present invention includes hosted GatewayAPI web service located behind the hosted system's firewalls, Hosting Interface API web service located behind the firewall of the web server 16 that communicates with the hosted GatewayAPI, and integration services that communicate with the interface web service, located on the data servers 12 and 14. It is to be understood that locations of the services and additional services may be used without departing from the scope of the invention.

The GatewayAPI in accordance with the exemplary embodiment of the present invention extracts data from the hosted system's internal applications. The GatewayAPI accesses known APIs of other commercial software systems and databases as well as any custom code needed to pull data from the hosted system's internal proprietary applications. In an exemplary embodiment, the GatewayAPI extracts data and return the data to the web service client as either a ADO dataset or XML document.

The Hosting Interface API in accordance with the exemplary embodiment of the present invention provides the ability to communicate with the Gateway API and contains interface logic to transform data into a common data format. The Hosting Interface API, for example, pulls hourly, snapshot, and market data into the data store 18. The Hosting Interface API also generates log events from SCADA information.

The integration services in accordance with the exemplary embodiment of the present invention drive the communication interfaces. The integration services utilize mapping data to execute, monitor, and report on scheduled interfaces for each hosted system. The in accordance with the exemplary embodiment of the present invention, the integration services includes “retry” logic to ensure that data is not missed due to any sort of system failure.

Once the qualitative and quantitative information of the hosted power generating unit (e.g., power plant//distributed micro-generator 20a), the web server 16 of the hosting monitoring center 10 provides customized reports to the client devices 40 through report interfaces implemented on the web server 16. The report interfaces in accordance with an exemplary embodiment of the present invention are built from a customizable library of report interfaces. The report interfaces of the present invention are customized using extensible markup language (XML) based “config files” that contain information about what data to extract and how to format the data on a report interface. Accordingly, the XML config files in accordance with the present invention combine data from any number of disparate systems into a comprehensive report. The XML config files of the present invention simply map data from the data store 18 directly to a report interface without requiring any customized code.

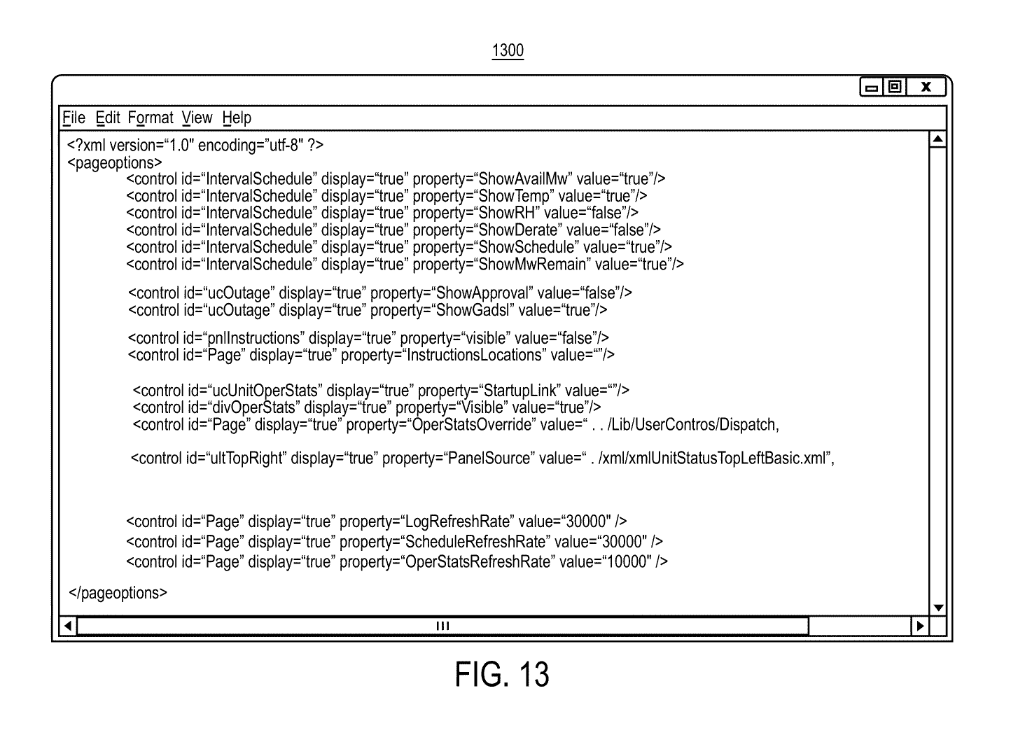

An exemplary embodiment of the present invention includes page config files and reports config files. The content of a page config file 1300, as shown in FIG. 13, includes XML that may direct the page to change any property of the page itself, or any property of any control on the page. This allows the user interface to be changed without writing any code and increases maintainability across multiple client devices 40. For example, when the page initially loads, the browser automatically looks for a page config file. If a page config file is found, the browser processes the XML for the page contained in the page config file. Each page or control property identified in the XML is then set based on the page config file setting. To illustrate, a button on the page may be hidden by setting the visible property of the button equal to hidden. Furthermore, properties have been created on certain pages such a unit status report interface, to be explained below, that allow customization of entire sections of the page through the use of custom user controls.

The reports config file defines the layout of a report interface using XML included in the reports config file. The reports config file includes XML fragments for each object to be displayed on the report interface (e.g., graph, pie chart, data table, etc.). The XML fragment includes information specific to the object being shown (e.g., location on report, height, width, colors, etc.) as well as mapping information back to the data store 18 as to what data should be displayed. There may be mappings to multiple stored procedures defined for a single report object. For example, a chart may pull hourly megawatt (MW) data from one stored procedure and hourly price information from another in conjunction with a reporting engine to be described below. In an exemplary embodiment, a reports config file may be defined for a single report but may have different configurations depending on what hosted system (e.g., power plant/distributed micro-generator) the report is for. For example, each reports config file may have a “default” configuration defined. For any hosted system (e.g., power plant/distributed micro-generator) or unit (e.g., non-distributed/distributed generators) referred to as “locations,” where the report is to have a different look and feel and/or different data source, a subsequent “override” XML fragment is defined for the location. Any location that does not have the override fragment reverts to the default layout.

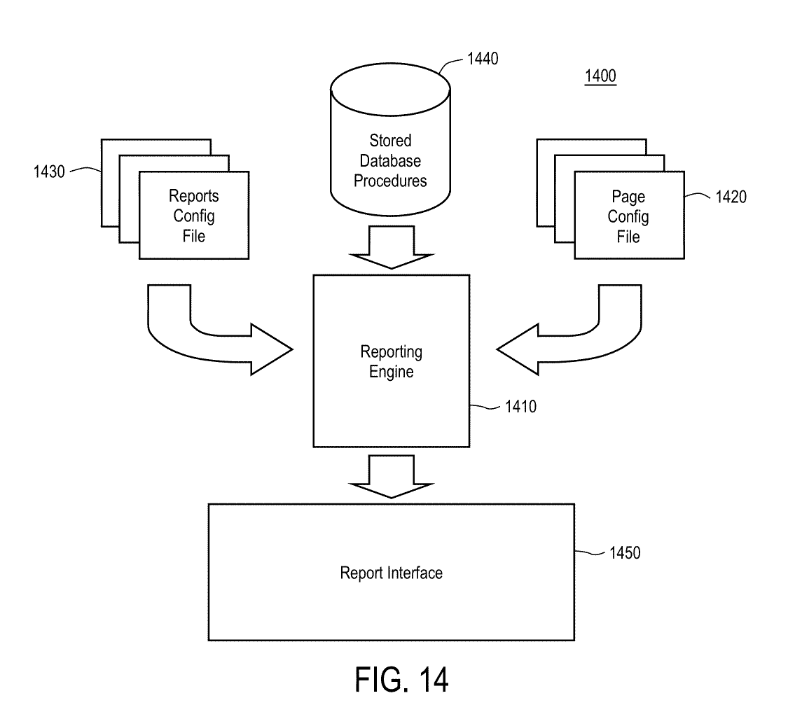

FIG. 14 shows a block diagram 1400 illustrating an exemplary embodiment of generating a report interface in accordance with the present invention. A reporting engine 1410 processes the page config file 1420 and reports config file 1430, executes the stored procedures identified 1440, and creates and formats the report objects on a report interface 1450. The reporting engine 1410 returns an HTML div containing the formatted report. The reporting engine 1410 loads the reports config file 1430 and identifies all of the stored procedures to call using an XPATH query. Once the reporting engine 1410 has gathered a list of stored procedures, the reporting engine 1410 executes each one, via a data access layer. By executing all stored procedures once and holding them in memory for report processing, extraneous database calls are eliminated to optimize performance. Each result set returned is stored in memory for the remainder of the report processing. The reporting engine then iterates through the report objects to build the actual report interface 1450. Object classes are defined for each possible report object (e.g., chart, pie chart, gauge, thermometer, note, table, etc.). The object classes include logic to generate HTML and format data appropriately for each type of report object. For each report object, the reporting engine 1410 creates an instance of the class and initializes the object generating basic HTML required. The reporting engine 1410 then iterates through each mapped data item to be illustrated in the report object and passes the data item to the class from the appropriate result set extracted from the database earlier. The class processes the data into HTML (or XML) for the report item and finally returns the completely formatted HTML, which is then inserted into the HTML div tags.

In an exemplary embodiment of the present invention, the report interface 1450 is categorized as one of the following: dashboard report interface, daily operational report interface, quantitative summary/drill-down report interface (also referred to as “unit performance” interface), an ad-hoc SCADA query interface, and unit status communication interface.

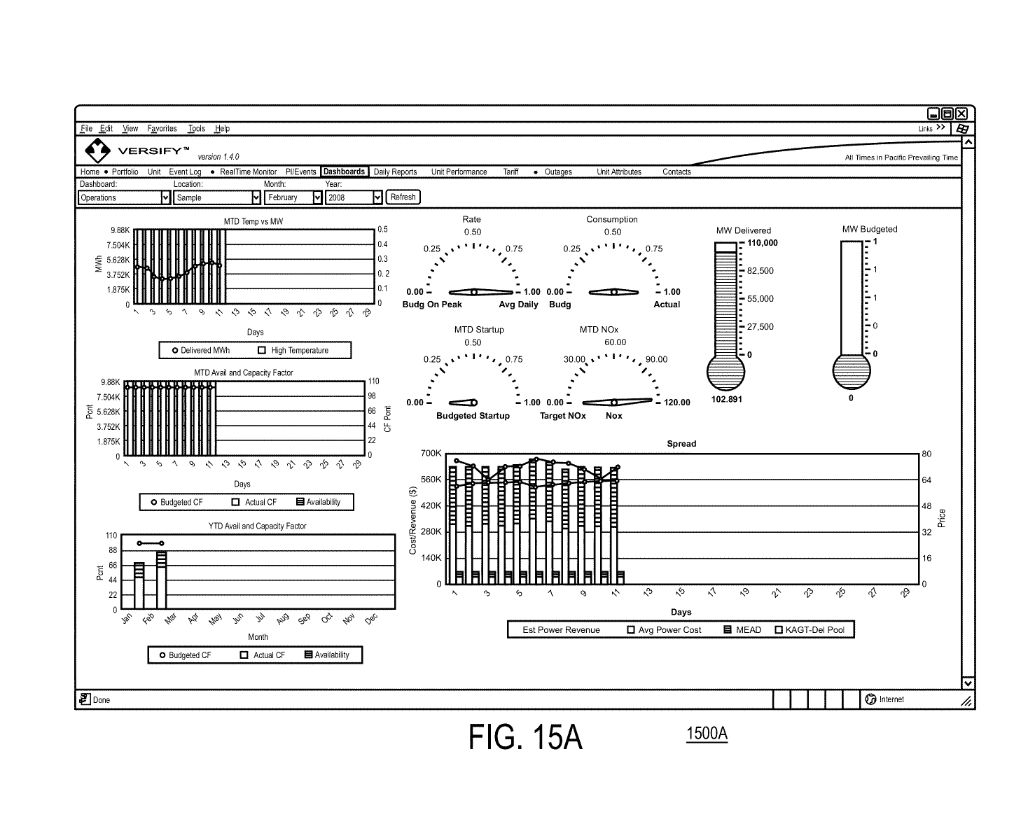

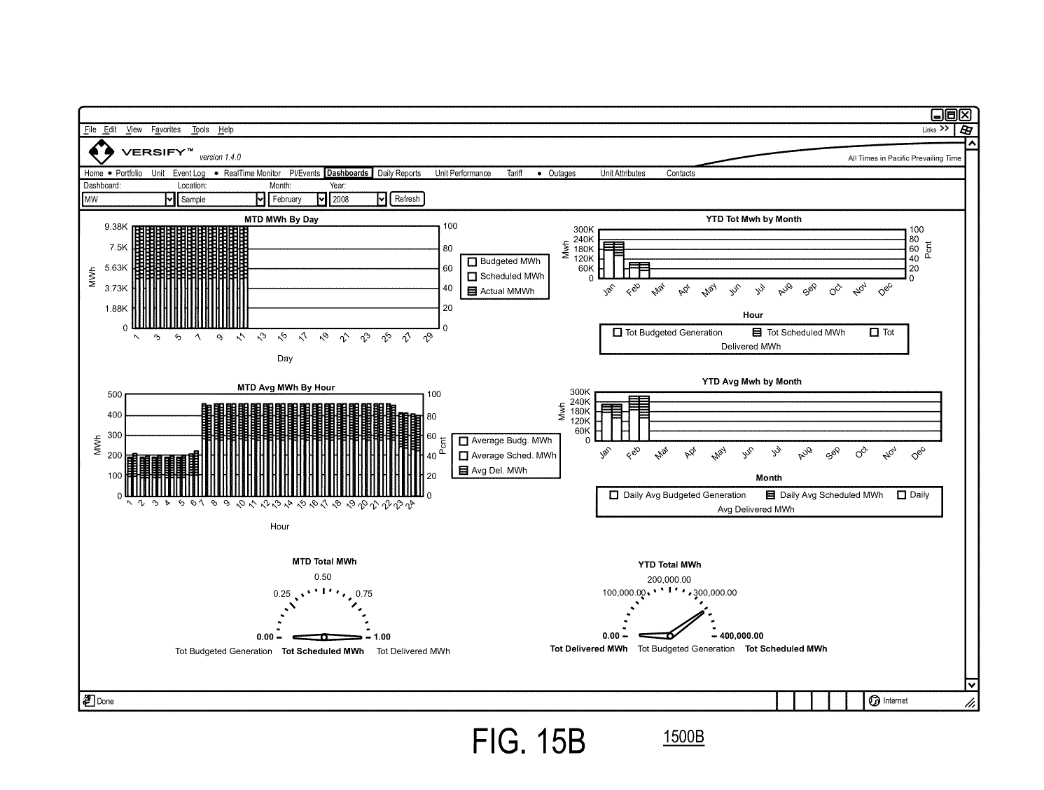

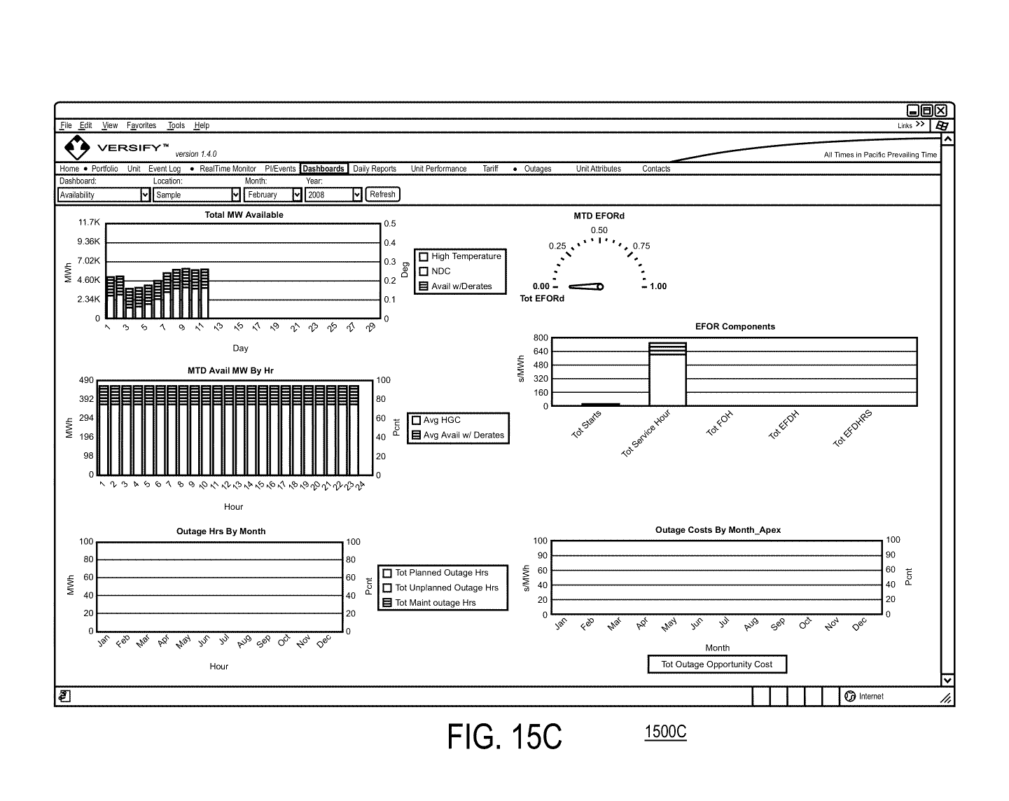

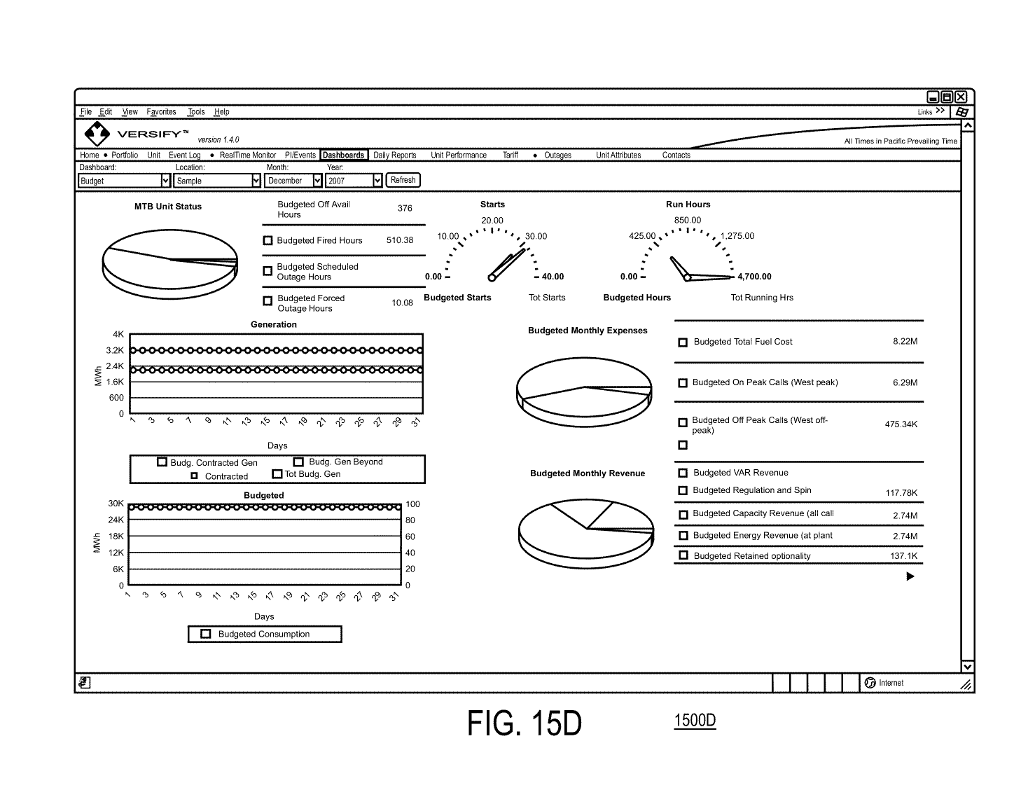

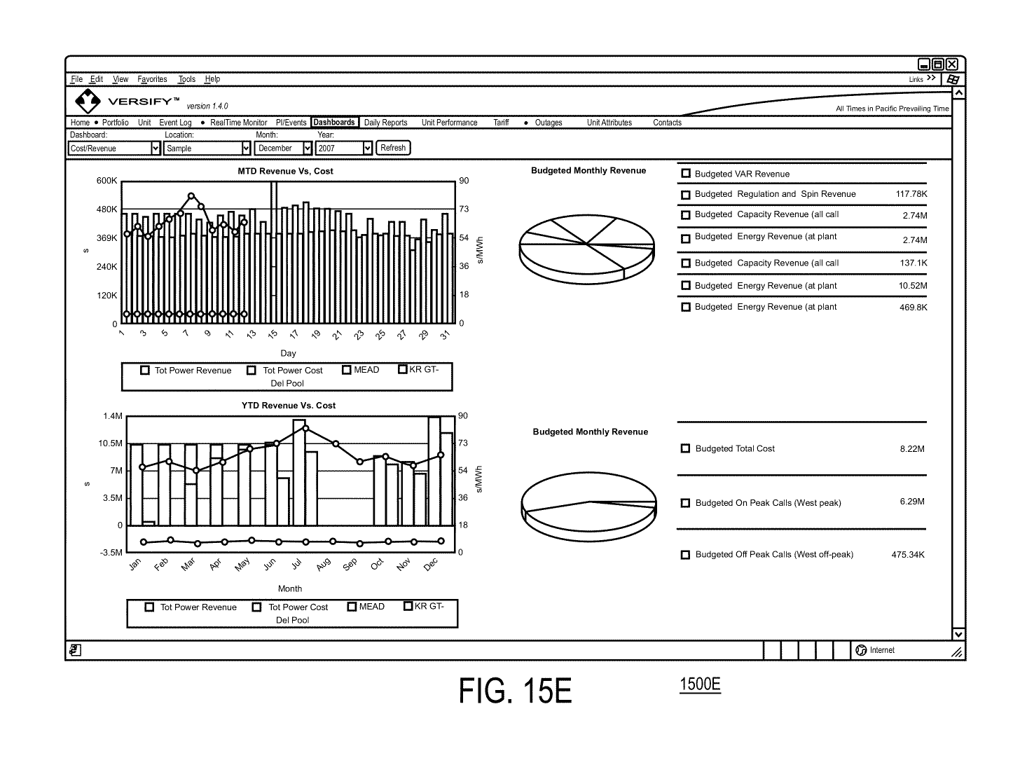

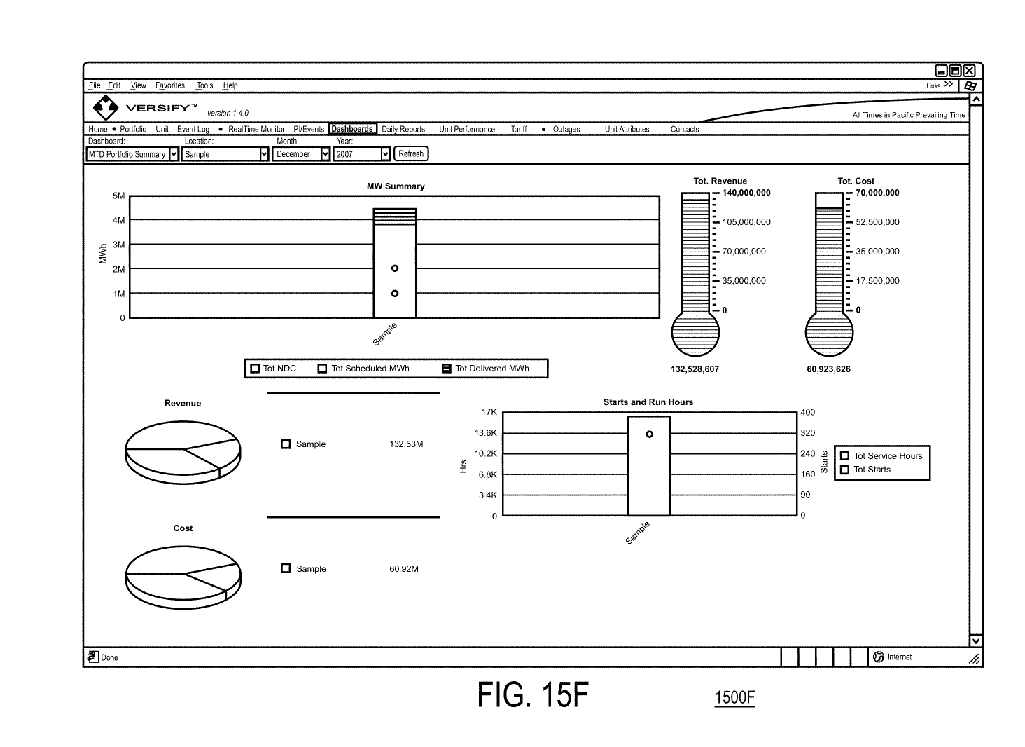

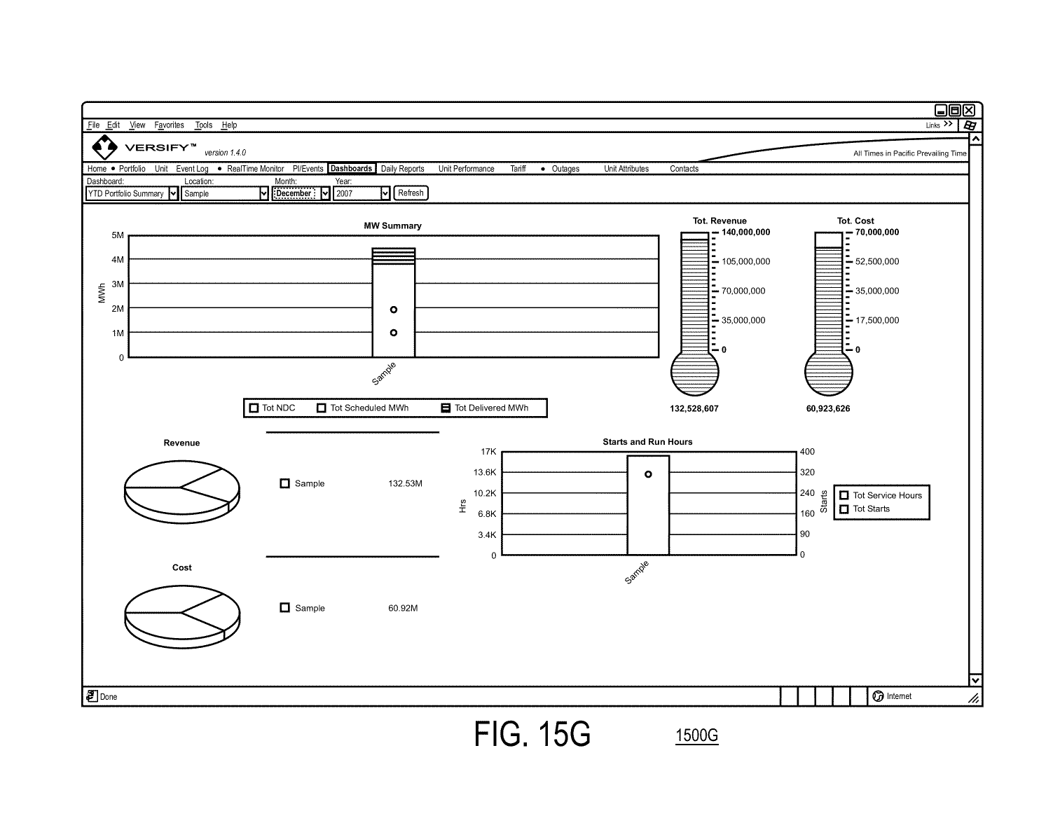

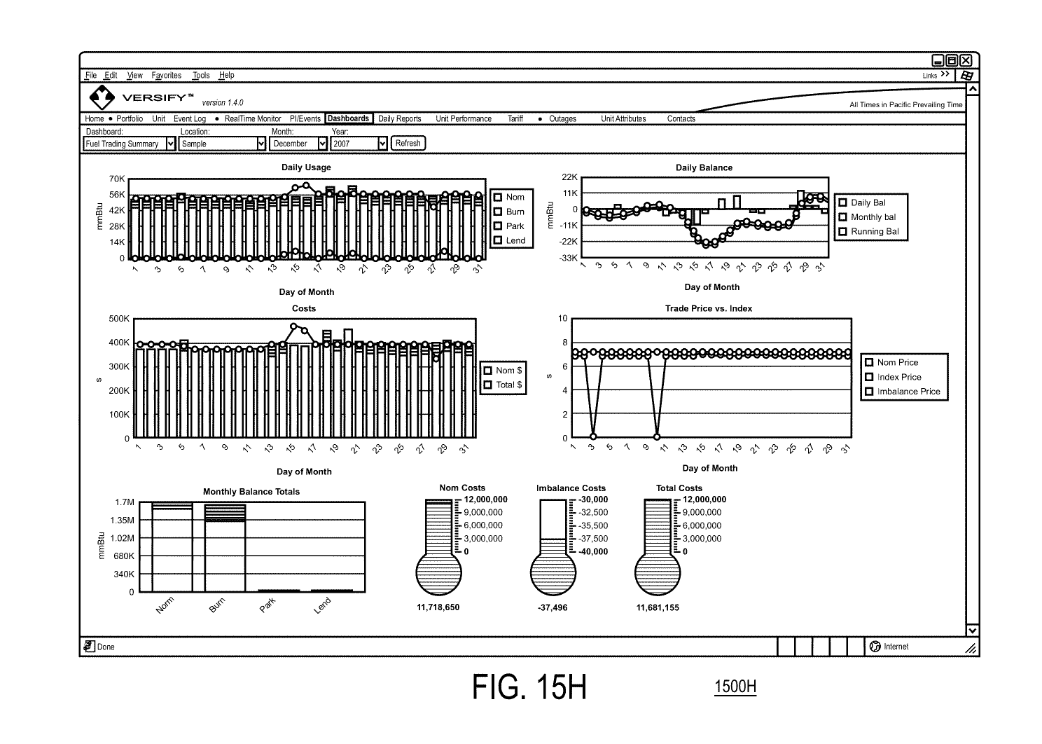

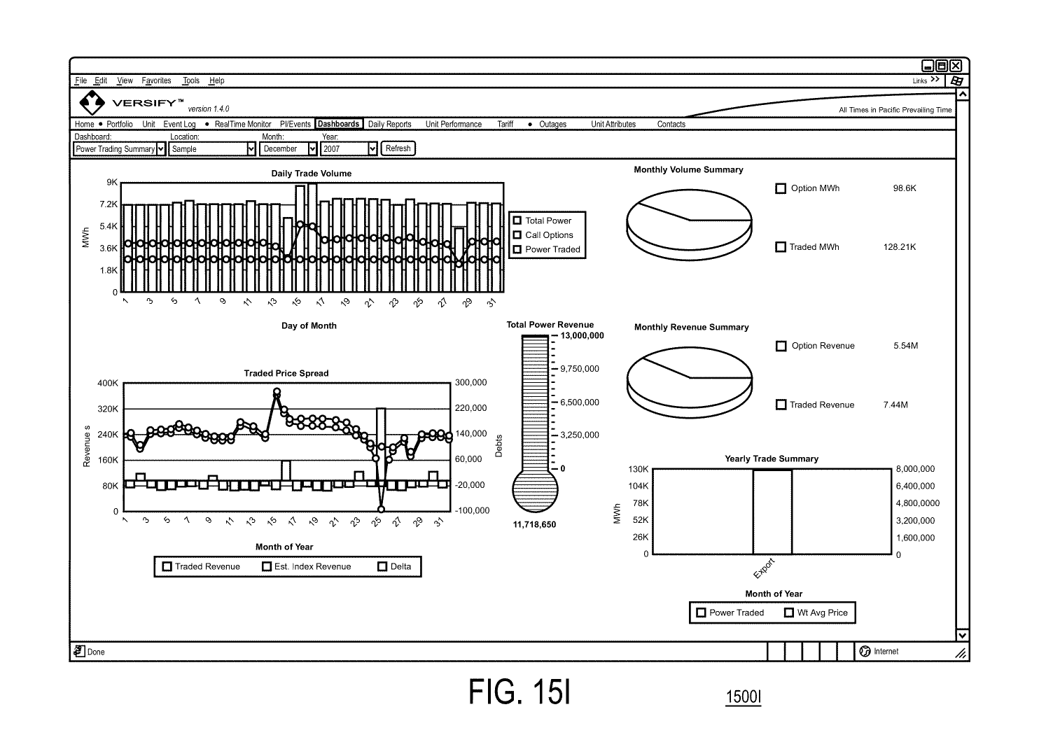

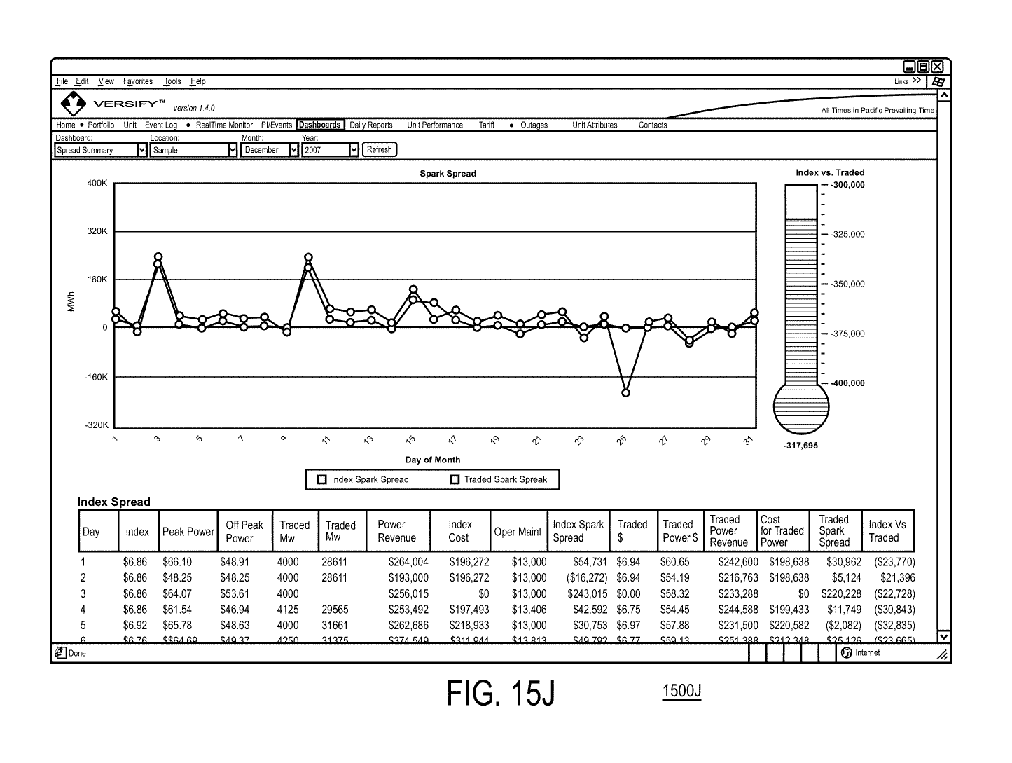

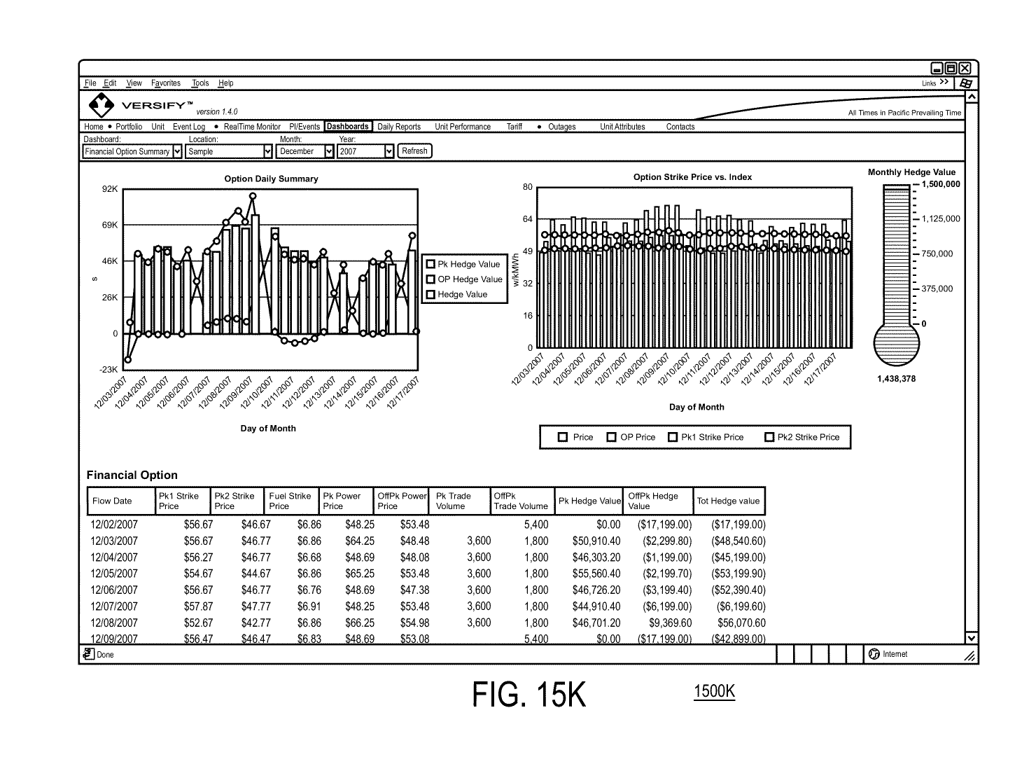

FIGS. 15A-15K show exemplary embodiments of the dashboard report interface 1500A-K. The dashboards page allows users to select any configured dashboard for any power plant/distributed micro-generator within the data store 18. FIGS. 15A-15K show exemplary embodiments of the following dashboards, respectively: Operations 1500A, Megawatts (MW) 1500B, Availability 1500C, Budget 1500D, Cost/Revenue 1500E, MTD Portfolio Summary 1500F, YTD Portfolio Summary 1500G, Fuel Trading Summary 1500H, Power Trading Summary 15001, Spark Spread Summary 1500J, and Financial Option Summary 1500K. It is understood that other dashboard interfaces may be included without departing from the scope of the present invention. In the exemplary embodiments, each dashboard is run for a selected month. However, other time ranges may be used without departing from the scope of the invention. For example, the user may select a power plant/distributed micro-generator (i.e., location) and a month out of a year, and refresh the report. An XML:HTTP callback is made from the browser on the client device 40 to the web server 16. The web server 16 receives the XML:HTTP request and creates an instance of the reporting engine 1410 described above. The reporting engine 1410 builds the report interface 1450 as described above, which may be an HTML div with report objects in it. The div is returned to the browser on the client device 40 that initiated the XML:HTTP call. The client device 40 refreshes the page on the screen with the newly created report. As shown in FIGS. 15A-15K, the dashboard interface includes a combination of report objects, such as gauges, bar graphs, line graphs, pie charts, and tables to provide an overall performance view of the selected location by integrating the qualitative and quantitative data obtained from the disparate data sources 20, converted into a common format, and stored in the data store 18. The report object may be animated as the information is provided to show movement of the various gauges, bar graphs, line graphs, pie charts, and other graphical representations.

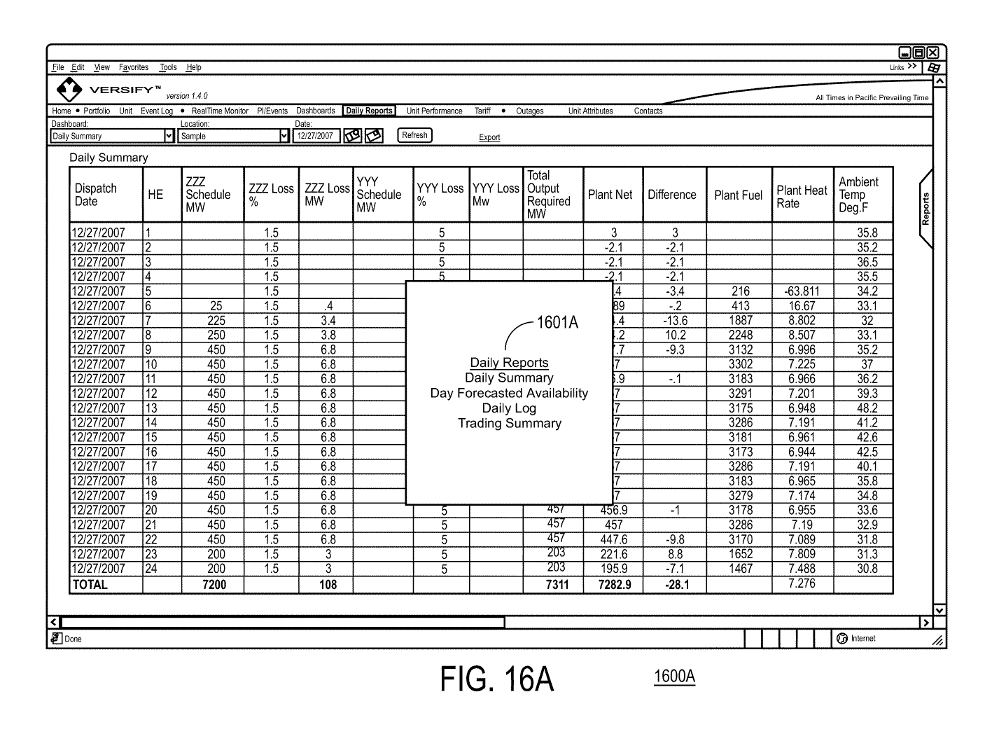

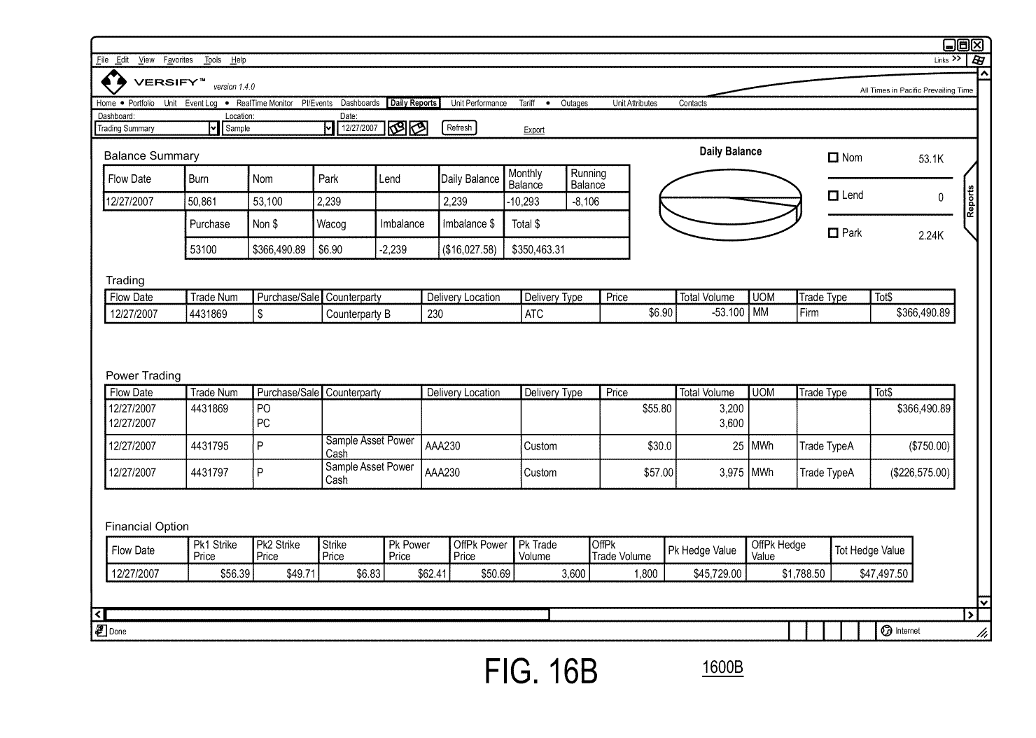

FIGS. 16A and 16B show exemplary embodiments of the daily report interface 1600A-B. The daily reports page 1601A allows a user to select a configured daily report. FIGS. 16A and 16B show the Daily Summary 1600A and Trading Summary 1600B, respectively. Other daily reports may include Day Forecasted Availability and Daily Log. It is to be understood that other daily summary reports may be included without departing from the scope of the invention. For example, the user selects a power plant/distributed micro-generator (i.e., location), a reporting day, and refreshes report. An XML:HTTP callback is made from the browser of the client device 40 to the web server 16. The web server 16 receives the XML:HTTP Request and creates an instance of the reporting engine 1410 described above. The reporting engine 1410 builds the report as described above, which may be an HTML div with report objects in it. The div is returned to the browser on the client device 40 that initiated the XML:HTTP call. The client device 40 refreshes the page on the screen with the newly created report. The daily report interface provides a summary of daily operational and financial activities of the selected location by integrating the qualitative and quantitative data obtained from the disparate data sources 20, converted into a common format, and stored in the data store 18.

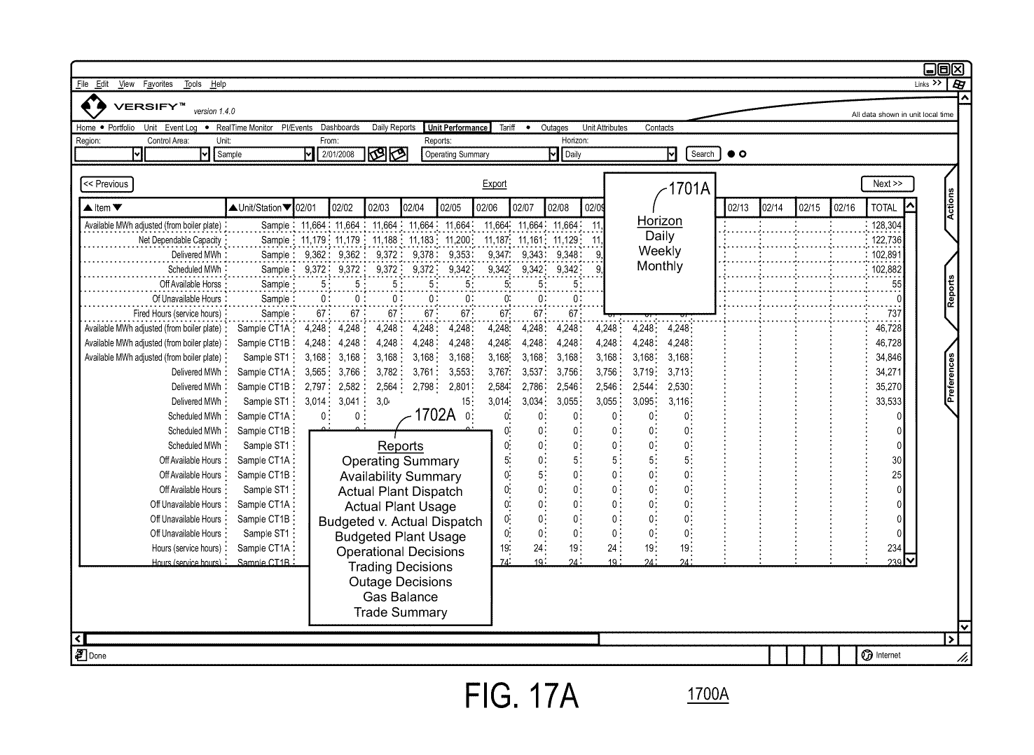

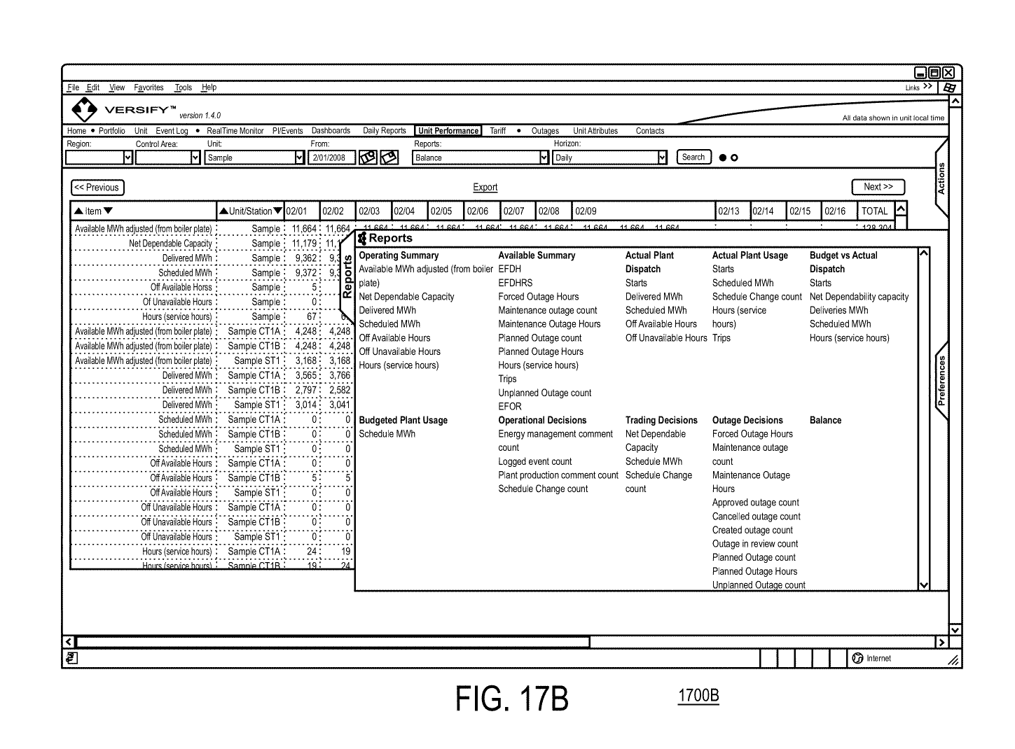

FIGS. 17A and 17B show exemplary embodiments of the unit performance report interface 1700A-B. The unit performance report interface 1700A-B includes quantitative reports 1701A for daily, weekly, and monthly time horizon, for example. In addition, the unit performance report interface includes drill down capability so that hourly detail report data may also be retrieved. In the exemplary embodiment, the unit performance report interface includes the following reports 1702A (all of which are also available for distributed micro-generators): Operating Summary, Availability Summary, Actual Plant Dispatch, Actual Plant Usage, Budgeted v. Actual Dispatch, Budged Plant Usage, Operational Decisions, Trading Decisions, Outage Decisions, Gas Balance, and Trade Summary. It is understood that other summaries may be included without departing from the scope of the invention. In the exemplary embodiment, the unit performance report interface and the items displayed are maintained in an XML fragment in the unit performance page's reports config file 1430. For example, a user selects a report, a time frame, and a time horizon to initiate the report. The browser of the client device 40 initiates a callback to the web server 16, which in turn calls a stored procedure 1440. The stored procedure includes logic to summarize the data to the selected level (daily, weekly, monthly). When the result set is returned to the web server 16, the page is correctly formatted with the data into a table with the correct number of columns (e.g., based on daily, weekly, or monthly) and returns the table to the browser on the client device 40. As shown in FIG. 17B, the unit performance page 1700B also includes drill down capability to drill down into a finer granularity (e.g., hourly details). Database mapping tables are used to map summary items on the main page to the hourly detail. When a user clicks on a cell on the main report, the browser on the client device 40 initiates a callback. The callback request is received by the web server 16, and a stored procedure 1440 is executed to retrieve mapped detail from the data store 18. The mapped detail is returned to the client device 40 as a table, for example.

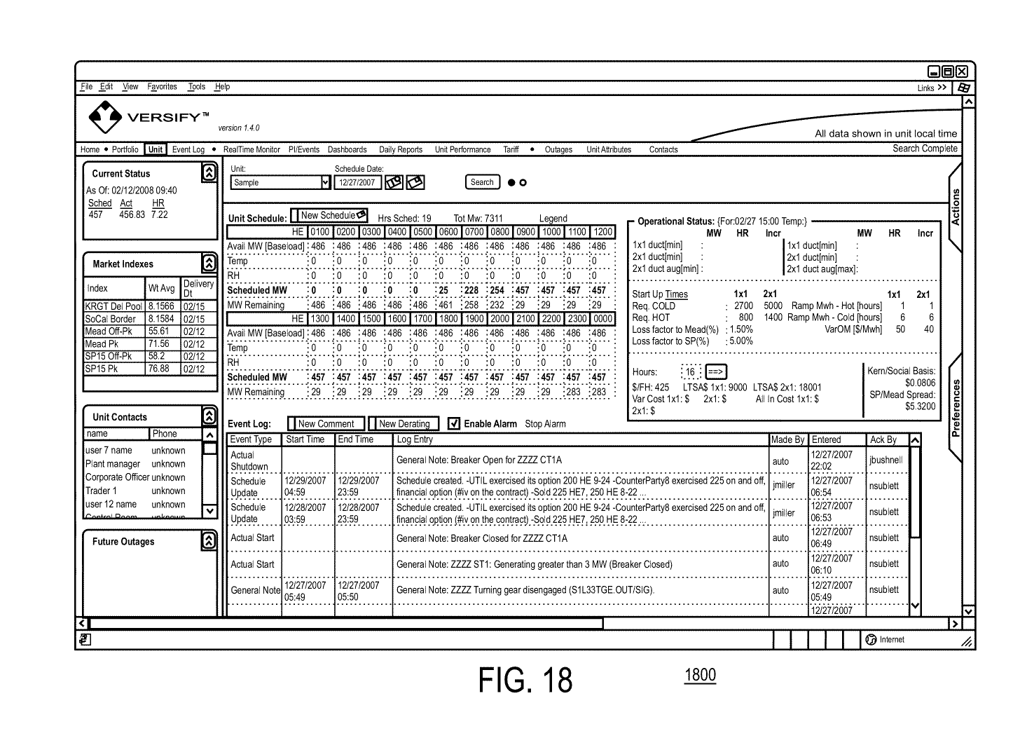

FIGS. 18-21B show exemplary embodiments of ad-hoc SCADA query interface and unit status communication interface in accordance with the present invention. For example, FIG. 18 illustrates an exemplary unit interface 1800 that displays operational information of a selected unit. The information may include current status, operational statistics, schedules, event logs for the unit, and market data. The information may be displayed for a selected date. It is to be understood that other information regarding the selected unit may be included without departing from the scope of the invention.

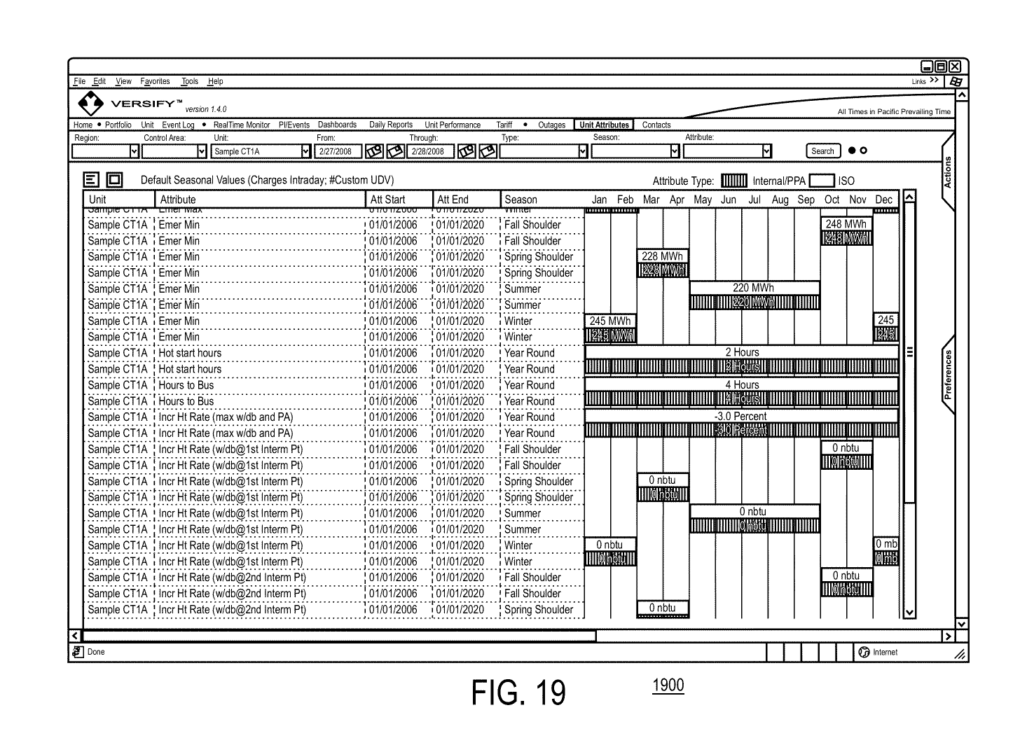

FIG. 19 illustrates an exemplary unit attribute interface 1900 that displays a summary of the operational attributes based on region, control area, unit, and date range, for example. Other criteria, such as type, season, and attribute may be selected for viewing.

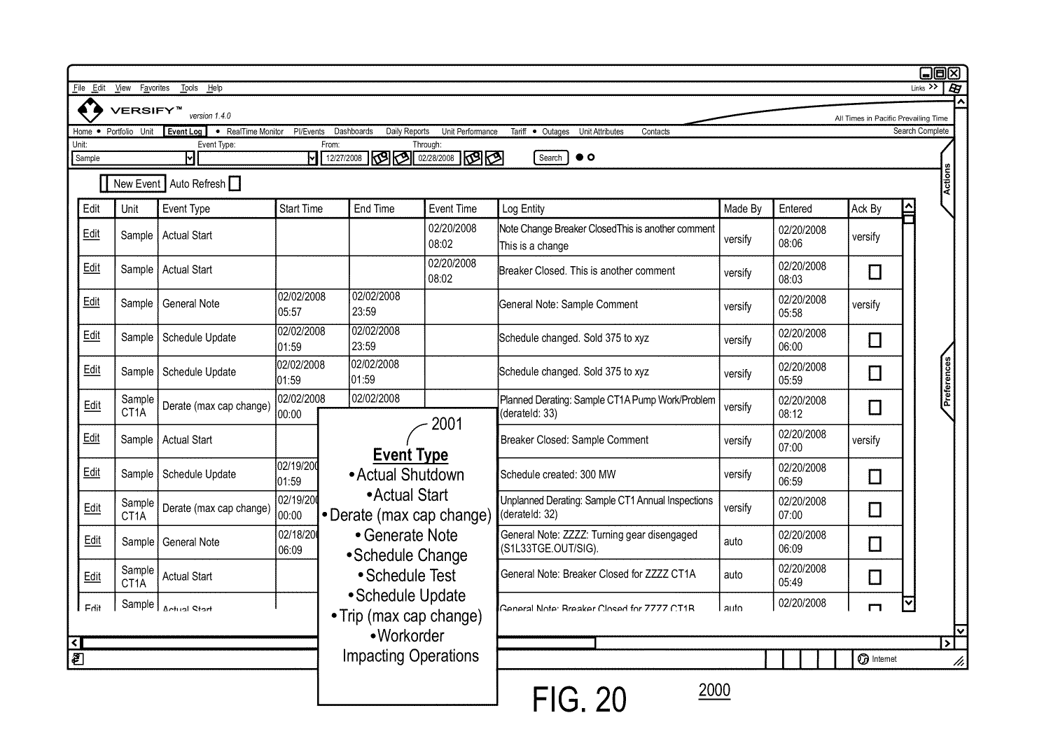

FIG. 20 illustrates an exemplary event log interface 2000 for a selected unit. The event log may be sorted based on event type and date range, for example. In an exemplary embodiment, the event types 2001 may include, but are not limited to: Actual Shutdown, Actual Start, Derate (max cap change), General Note, Schedule Change, Schedule Test, Schedule Update, Trip (max cap change), and Workorder Impacting Operations.

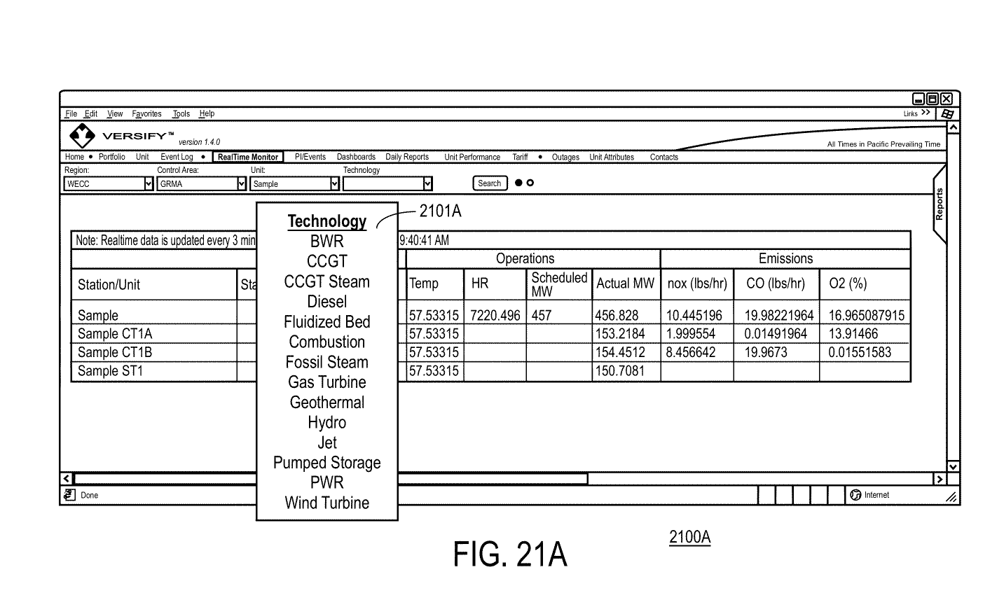

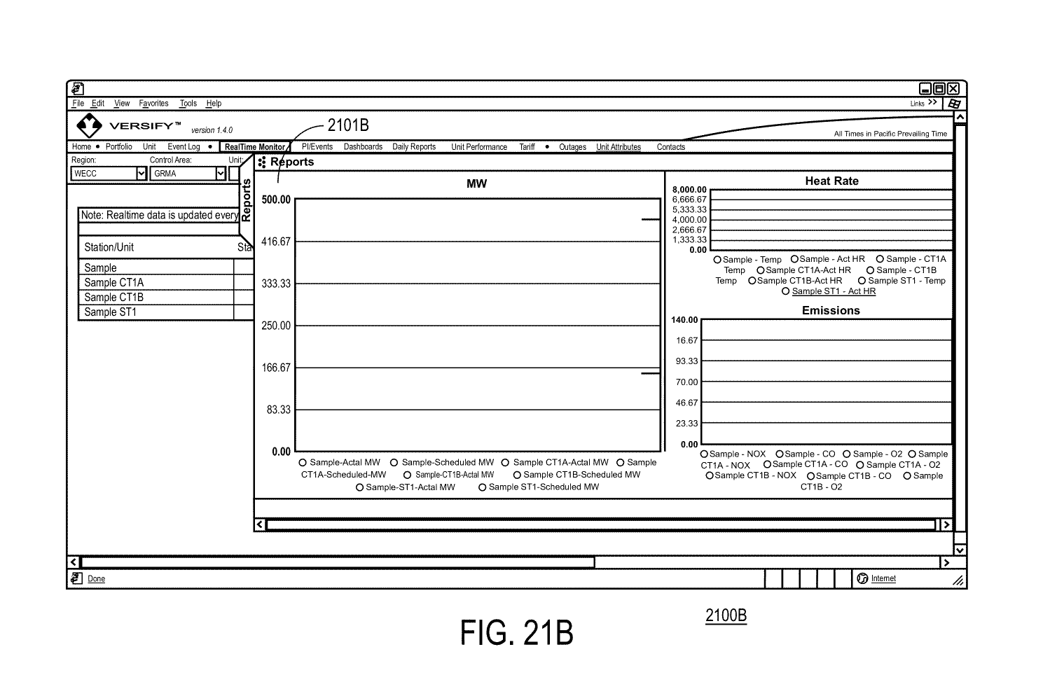

FIGS. 21A and 21B illustrate an exemplary (near) real time monitor 2100A for a selected unit. In an exemplary embodiment, the operational data of a hosted power plant/distributed micro-generator is updated every three (3) minutes. However, the period for update may be changed without departing from the scope of the present invention. The monitor may be selected based on region, control area, unit, and technology. Technology criteria 2101A may be include, but are not limited to: BWR, CCGT Gas, CCGT Steam, Diesel, Fluidized Bed, Combustion, Fossil Steam, Gas Turbine, Geothermal, Hydro, Jet, Pumped Storage, PWR, and Wind Turbine. As shown in FIG. 21B, the real time monitor 2100B includes a pull-out 2101B to provide graphical representation of the monitored parameters, such as megawatt (MW), heat rate, and emissions. Other parameters may be included without departing from the scope of the present invention.

In addition to the real time monitoring, a feature of the present invention includes alarm monitoring and tracking of user-defined significant events. For example, the monitoring center 10 of the present invention tracks and logs when a hosted unit comes on-line or goes off-line. The monitoring center 10 tracks alarms against any generation operational parameter that is archived in the time-series data store 18. This is implemented by querying the time-series historical data store 18 for values archived for a selected operational parameter over a set time interval. For example, for a generator unit on-line alarm, the monitoring center 10 queries the historical archive in the data store 18 for a 15 minute interval and examines breaker status recorded during that timeframe. Any change in the monitored value represents an event, which triggers an alarm. Once examination for the given parameter and time period is complete, the monitored time interval is marked as examined and the alarm as tracked. Future monitoring of the historical archived data in the data store 18 will check subsequent intervals based on what has already been marked as examined.

The alarming feature is not limited to tracking on/off types or digital state data. Rather, monitored recorded events may also be examined based on numerical thresholds. For example, generation managers may wish to monitor megawatt (MW) levels and create different events based on the number of megawatts produced at a power generation/distributed micro-generator facility. The plant may want to be alerted when the megawatt (MW) level reaches a specific level, such as 100, 250, and 500. Each MW level reached requires a unique action or log entry to be recorded. Such alarms are defined in the monitoring center 10 to initiate tracking and logging. For example, in an exemplary embodiment of the present invention, alarms may be defined by noting the following data points:
Archive historian database;
Archive historian data point to monitor;
Compare value (or alarm value);
Alarm log message to create when value is greater than comparison value;
Alarm log message to create when value is less than comparison value; and
Alarm log message to create when value is equal than comparison value.

To ensure all intervals are examined, examined archived data may be marked by noting:
Archive historian point examined;
Alarm that is tracked;
Examination start time; and
Examination end time.

This serves to baseline subsequent interval checks. It is to be understood that other notations may be made without departing from the scope of the present invention.

In accordance with an exemplary embodiment of the system and method of the present invention, monitoring of any number of hosted power generation/distributed micro-generator units is realized by collecting qualitative (e.g., event data) and quantitative (e.g., cost, market data) information from a plurality of disparate data sources, converting the disparate data into a common data format, and storing the transformed data to be served up through a communications network, such as the Internet, to a plurality of client devices that may be located anywhere in the world. The various report interfaces in accordance with the present invention allows the user to monitor the performance of the hosted power generation/distributed micro-generator units including a comparison of the actual performance of the monitored unit with expected (i.e., budgeted) performance. The system and method of the present invention generates reports using XML config files to reduce the time to build and customize any number of reports. The XML config files allows developers to simply map data from database stored procedures directly to a report without writing any code to reduce the time required to deliver a report and eliminate the need for any code changes to existing applications.

It will be apparent to those skilled in the art that various modifications and variations can be made in the system and method of the present invention without departing from the spirit or scope of the invention.

For example, while the following description is directed to increasing power capacity to the grid by providing aggregated power generated by the micro-generators (i.e., supply-side solution), the system and method of the present invention can also increase power capacity to the grid by providing aggregated power reduction at the demand resources (i.e., demand-side solution). Demand response is a form of distributed generation that lowers or balances load on the grid by reducing demand from large commercial and industrial users rather than using micro generators to reduce or balance the load on the grid by adding more supply. In other words, in demand response, the demand resources (e.g., large commercial and industrial users) become micro-generators by giving power back to the grid by reducing demand. The system and method of the present invention supports aggregation, monitoring, and management of demand response resources as a form of distributed generation.

Thus, it is intended that the present invention cover the modifications and variations of this invention provided they come within the scope of the appended claims and their equivalents.

What is claimed is:

1. An energy distribution system for delivering energy from distributed micro-generator energy sources to a power grid, the system comprising:
monitoring circuitry configured to monitor and communicate use of the distributed micro-generator energy sources, wherein the distributed micro-generator energy sources are configured to delivery energy to the power grid;
a manager configured to develop a model describing an aggregation of the micro-generator energy sources based on an operating status and operating characteristics of the micro-generator energy sources; and
an aggregator configured to aggregate the distributed micro-generator energy sources into an energy unit based on the model developed by the manager, the energy unit representing a chunk of energy to be provided to the power grid.
